(19) United States
(12) Patent Application Publication
(10) Pub. No.: US 2011/0094196 A1
(43) Pub. Date: Apr. 28, 2011

(54) Ecologically clean method and apparatus for water harvesting from air

(76) Inventor: Yuri Abramov, Holon (IL)

(21) Appl. No.: 12/774,936

(22) Filed: May 6, 2010

Related U.S. Application Data
(60) Provisional application No. 61/175,799, filed on May 6, 2009.

(51) Int. Cl. E03B 3/28; B01D 45/00

(52) U.S. Cl. 55/342; 55/440; 55/418

(57) ABSTRACT

An ecologically clean water condensation engine exposed to a humid wind, said water condensation engine includes a cascade of sequential profiled horn-tubes and a set of wing-like profiled details. The cascade of sequential profiled horn-tubes forms a fast and cooled out-flowing air flux, which reaches the set of wing-like profiled details. The set of wing-like profiled details acts on the fast and cooled out-flow air flux, which in turn provide acceleration of air portions and eddying and vortices with in the air portions. The air portions inherently undergo a decrease in inner pressure accompanied by a further temperature decrease, thereby, triggering condensation of water-vapor into water-aerosols and the water-aerosols collect into drops of dew upon surfaces of the wing-like profiled details.

### FIELD OF THE INVENTION

The invention relates generally to ecologically clean technology, and, more particularly, to extraction of distilled water from humid air.

### BACKGROUND OF THE INVENTION

In most geographic areas prior art water sources are placed far from the actual utilization point. In such cases, the ability to extract water from air offers a substantial advantage, because there is no need to transport the water from a distant source to a local storage facility. Moreover, if water is continuously harvested, local water reserve requirements are greatly reduced.

Another reason for water-from-air extraction is in those regions of the world where sources of potable water are scarce or absent.

An exemplary situation is when a massive forest fire needs to be extinguished, and typically great expense is incurred for an airplane to supply an enormous amount of water to the scene of action. In this case the ability to trigger substantial rainfall would be highly desirable.

Another important application is an ecologically clean method for solar thermal energy collection with focusing plates, for example, in the form of parabolic troughs, wherein the total area of all the plates is as big as possible. On the one hand, it is preferable that the focusing plates are clean from dust. On the other hand, normally, the system occupies a big area in an open space, where natural dust always covers the plates, thereby reducing the efficiency of solar energy collection. The problem of cleaning the plates might be solved by repeated washings with distilled water.

Sometimes an effect of air saturated with water is unwanted, as for example, in plant growing incubators, where a desired high air temperature results in unwanted air saturation.

Given the ubiquitous nature of water in the vapor phase, it is possible to establish a sustainable water supply at virtually any location having air being refreshed, if one can develop a technology that efficiently harvests water from air. Possession of such technology will provide a clear logistical advantage to supply agriculture, industry and townspeople with water and to control ecological conditions.

For example, a water production unit, which uses a desiccant wheel for extracting water from an air loop, where a portion of the air loop is heated using exhaust from, for example, a vehicle to regenerate the desiccant wheel, is described in U.S. Pat. No. 7,251,945 “Water-from-air system using desiccant wheel and exhaust” by Stephen Tongue. The method described assumes thermal energy consumption, and the suggested apparatus comprises moving parts of the mechanism.

Another method for extracting water from air is described by Spletzer, in three U.S. Pat. No. 6,360,549—Method and apparatus for extracting water from air; U.S. Pat. No. 6,453,684—Method and apparatus for extracting water from air; and U.S. Pat. No. 6,511,525—Method and apparatus for extracting water from air using a desiccant. The method is described as four steps: (1) adsorbing water from air into a desiccant, (2) isolating the water-laden desiccant from the air source, (3) desorbing water as vapor from the desiccant into a chamber, and (4) isolating the desiccant from the chamber, and compressing the vapor in the chamber to form a liquid condensate. The described method assumes electrical energy consumption, and the suggested apparatus comprises moving parts.

In both of the above approaches there is a need for energy consumption and mechanisms comprising moving parts, thereby requiring a degree of maintenance of the systems. This makes the water harvesting neither reliable nor inexpensive. Moreover, the fuel or electrical energy consumption renders these prior art methods unclean ecologically.

Yet another method and apparatus for atmospheric water collection is described in U.S. Pat. No. 7,343,754, “Device for collecting atmospheric water” by Ritchey. This method is based on moist air convection due to the temperature difference between air and ground. However, such slow convection does not allow for producing industrial amounts of water.

U.S. Pat. No. 6,960,243, “Production of drinking water from air” by Smith, et al, describes an adsorption-based method and apparatus, where the adsorption process is modified to reduce heating energy consumption. However, the adsorption method is also intended for producing small quantities of water.

The water condensation process is an exothermal process. I.e., when water is transformed from vapors to aerosols and/or dew, so-called latent-heat is produced, thereby heating the aerosols and/or dew drops themselves, as well as the surroundings. The pre-heated aerosols and/or dew drops subsequently evaporate back to gaseous form, thereby slowing down the desired condensation process.

FIG. 1 is a schematic drawing of a classical prior art profile of an airplane wing 10. It is well-known that there is a lift-effect of the airplane wing 10, which is a result of the non-symmetrical profile of the wing. An oncoming air stream flows around the non-symmetrical profile of wing 10, drawing forward the adjacent air due to air viscosity, according to the so-called Coanda-effect. The axis 11 of wing 10 is defined as separating the upper and lower fluxes. Axis 11 of wing 10 and the horizontal direction of the oncoming air flux 12 constitute a so-called “attack angle” 13.

Firstly, a lifting-force is defined by attack angle 13, which redirects the flowing wind. Secondly, when attack angle 13 is equal to zero, wing 10, having an ideally streamlined contour, provides that the upper air flux front 14 and the lower air flux front 15 meet behind wing 10. Upper air flux front 14 and lower air flux front 15, flowing around wing 10, incur changes their cross-section square areas and are accelerated convectively according to the continuity principle: ρSv=Const, where ρ is the density of flux; ν is the flux velocity, and S is the flux cross-section square. As a result, upper air flux 14, covering a longer way, runs faster, than lower flux 15. According to Bernoulli's principle, this results in less so-called static pressure on wing 10 from upper flux 14 than the static pressure from the lower flux 15. If upper flux 14 and lower flux 15 flow around wing 10 laminallylaminary, the difference of the static pressures is defined as

$$Δ P = C ρ \frac{{v}^{2}}{2} ,$$

where ΔP is the static pressure difference defining the lifting force when attack angle 13 is equal to zero, C is the coefficient, depending on wing 10's non-symmetrical profile, ρ is the density of the air; and ν is the velocity of the air flux relative to wing 10. In practice, there are also turbulences and vortices of the fluxes, which are not shown here. The general flowing, turbulences and vortices result in air static pressure distribution, particularly, in local static pressure reduction and local extensions of the flowing air. Considering a certain portion of air flowing around wing 10, and referring to the Klapeiron-Mendeleev law concerning a so-called hypothetic ideal gas state:

$$\frac{P V}{T} = n R ,$$

where n is the molar quantity of the considered portion of the gas, P is the gas static pressure, V is the volume of the gas portion, T is the absolute temperature of the gas, and R is the gas constant, there are at least two reasons for changes in the gas state parameters of the air portion flowing around wing 10. First, for relatively slow wind, when the flowing air can be considered as incompressible gas, Gay-Lussac's law for isochoric process bonds the static pressure P with absolute temperature T by equation

$$\frac{Δ P}{P} = \frac{Δ T}{T} ,$$

i.e. reduced static pressure is accompanied with proportional absolute temperature decreasing ΔT. Second, for wind at higher speeds, running on a non-zero attack angle 13, when the air becomes compressible-extendable, the wind flowing around wing 10 performs work W for the air portion volume extension, wherein the volume extension process is substantially adiabatic. The adiabatic extension results in a change of the portion of gas internal energy, accompanied with static pressure reduction and temperature decrease. The work performed W of the wind flowing around wing 10 for the adiabatic process is defined as: W=nC_{V}ΔT_{α}, where C_{V} is the heat capacity for an isochoric process, and ΔT_{α} is the adiabatic temperature decrease of the considered air portion. The value of the adiabatic temperature decrease ΔT_{α}=T₂−T₁ is bonded with static pressure reduction by the relation: T₂/T₁=(P₂/P₁)^{(γ-1)/γ}, where P₁ and P₂ are static pressures of the considered air portion before and after the considered adiabatic process correspondingly, and γ is an adiabatic parameter, which depends on molecular structure of gas, and the value γ= 7/5 is a good approximation for nature air. Local cooling by both mentioned processes: isochoric and adiabatic pressure reduction, acts in particular, as a water condensation trigger. Moreover, if the wind flows around a wing with a velocity equal to or higher than the Mach number, i.e. the speed of sound, a well-known phenomenon of shock sound emission takes place. This shock wave is not caused by wing vibration, but it is at the expense of the internal energy of the air flow, that results in an air temperature shock decrease and thereby, provokes the process of vapor condensation into water-aerosols. For example, as is shown schematically in FIG. 1a, considerable amounts of water vapor condense into water-aerosols 17 and sublimate into micro-flakes-of-snow 18, which are observed behind the high-speed aircraft's 16 wings.

Reference is now made to prior art FIG. 1b, a schematic illustration of a convergent-divergent nozzle 100 and graphics of distribution of both parameters of gas 101: velocity 150; and static pressure 160 along the length of nozzle 100. A standard rocket nozzle can be modeled as a cylinder 140 that leads to a constriction 141, known as the “throat”, which leads into a widening “exhaust bell” 142 open at the end. High speed, and therefore compressible-extendable hot gas 101 flows through throat 141, where the velocity picks up 151 and the pressure falls 161. Hot gas 101 exits throat 141 and enters the widening exhaust bell 142. It expands rapidly, and this expansion drives the velocity up 152, while the pressure continues to fall 162.

FIG. 2 is a prior art table showing figures for weather conditions near the ground and how much water is in the air. Each cell 22 of the table comprises two numbers: upper and lower. The upper numbers show the “absolute humidity” in g/m³, i.e. how many grams of water vapor are in one cubic meter (1 m³) of air. The lower numbers show so-called “dew-point” temperature of the air in ° C. For example, at the air temperature of 50° C. and relative humidity of 70%, the absolute humidity is 58.1 g/m³ and the dew-point temperature is 43° C.

FIG. 2a is a prior art schematic representation of a breeze flux 24, crossing through a cube 21 of space, having all the dimensions of 1 m. If, for example, the breeze velocity is given as ν=5 m/sec, thereby, considering the described humidity conditions, each second (58.1×5=290.5) gram of water vapors cross through space cube 21. This means that approximately 1 ton of water vapor crosses space cube 21 per hour.

It is well-known that a “vortex tube”, also known as the Ranque-Hilsch vortex tube is a mechanical device that separates a compressed gas into hot and cold streams. It has no moving parts. Pressurized gas is injected tangentially into a swirl chamber and accelerates to a high rate of rotation. Due to a conical nozzle at the end of the tube, only the outer shell of the compressed gas is allowed to escape at the butt-end outlet. As a result this portion of the gas is found to have been heated. The remainder of the gas, which performs an inner vortex of reduced diameter within the outer vortex, is forced to exit through another outlet. As a result this portion of the gas is found to have been cooled.

FIG. 3 is a simplified exemplary prior art schematic illustration of the phenomenon of atmospheric tornados arising. If viscous air streams 32 and 33 having equal velocities at their propagation fronts, meet at an angle of almost 180°, friction between contacting parts of viscous air streams 32 and 33 results in re-distribution of air streams 32 and 33 fronts' velocities, as shown schematically by arrows 34 and 35. The re-distributed velocities redirect the fronts such that portions of air move angularly, as it is shown schematically by circulating arrows 36, and the two air streams 32 and 33 suck portions of each other according to the Coanda-effect. In addition, fresh portions of air streams 32 and 33 make new portions of the circulating vortex in the same space. Such a positive feedback loop may create local tornados having a high spin rate, wherein outer rotating air portions, which are speeding faster, suck new portions of air according to Bernoulli's principle and the Coanda-effect, and there is an inherent relative vacuum near the air rotation center. The portions of the rotating air at the same time can move vertically, so air portions move helically-vertical. A tornado is not necessarily visible; however, the intense low pressure, caused by the high wind speeds and rapid rotation, usually causes water vapor in the air to condense into a visible condensation funnel.

Thus, a phenomenon is observed that quickly circulating air triggers condensation of vapor molecules into water-aerosols. It may happen even if there are no dew-point conditions for water condensation in the nearest surroundings of the tornado. There are at least two mechanisms for triggering water condensation. One mechanism is explained by the fact that circulating air has inherent pressure distribution, wherein inner pressure is lower and outer pressure is higher. An air portion, which is entrapped by the high spin tornado, is convectively accelerated and adiabatically decompressed by the cyclone. Static pressure, reduced due to both the convective acceleration and adiabatically. The static pressure reduction is accompanied a decrease in air portion temperature. The air cooling provokes the water vapors to condense into aerosols.

Another trigger for water condensation derives from the fact that quickly revolving air, accompanied inherently by friction between the moving moist air parts, causes the phenomenon of air molecule ionization. The ionized molecules become the centers for condensing water polar molecules into easily visible aerosols.

There is therefore a need in the art for a system to provide an effective and ecologically clean mechanism for controlled water harvesting from air. Wind energy has historically been used directly to propel sailing ships or conversion into mechanical energy for pumping water or grinding grain. The principal application of wind power today is the generation of electricity. There is therefore a need in the art for a system to provide an effective mechanism for water harvesting from air utilizing nature wind power.

### SUMMARY OF THE INVENTION

Accordingly, it is a principal object of the present invention to overcome the limitations of existing apparatuses for extracting water from air, and to provide improved methods and apparatus for extracting water from air.

It is a further object of the present invention to provide methods and apparatus for more reliable water harvesting.

It is still a further object of the present invention to provide methods and apparatus for ecologically clean harvesting of water, where the forced water condensation from humid air is fulfilled by an engine powered by natural wind.

It is yet another object of the present invention to provide methods and apparatus for a more robust constructive solution without moving parts.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

All the above and other characteristics and advantages of the invention will be further understood through the following illustrative and non-limitative description of preferred embodiments thereof.

### BRIEF DESCRIPTION OF THE DRAWINGS

In order to understand the invention and to see how it may be carried out in practice, a preferred embodiment will now be described, by way of a non-limiting example only, with reference to the accompanying drawings, in the drawings:

FIG. 1 is a schematic drawing of a classic prior art profile of an airplane wing;

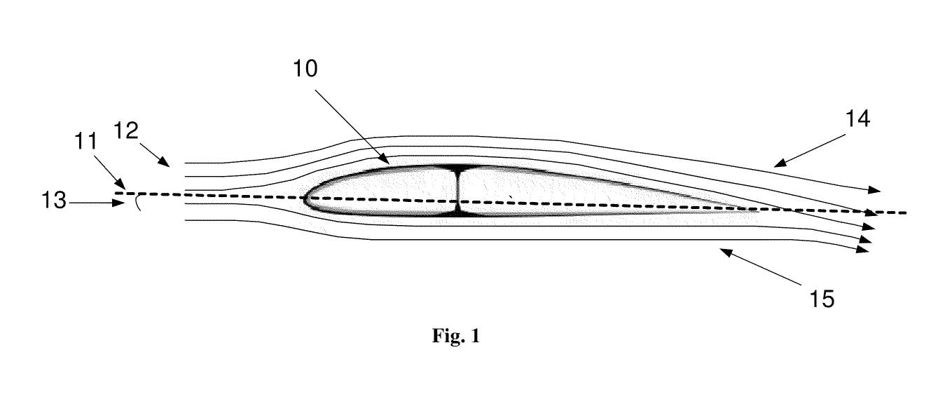

FIG. 1a is a prior art schematic illustration of condensing water-aerosols and sublimated micro-flakes-of-snow behind the wings of high-speed aircraft;

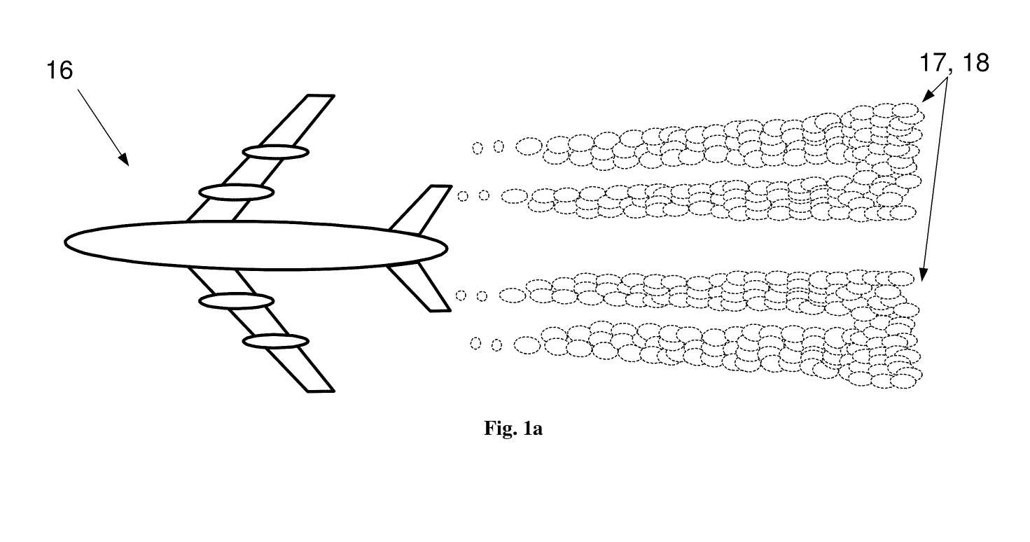

FIG. 1b is a prior art schematic illustration of a convergent-divergent nozzle and graphics of gas velocity and static pressure distributions along the nozzle length;

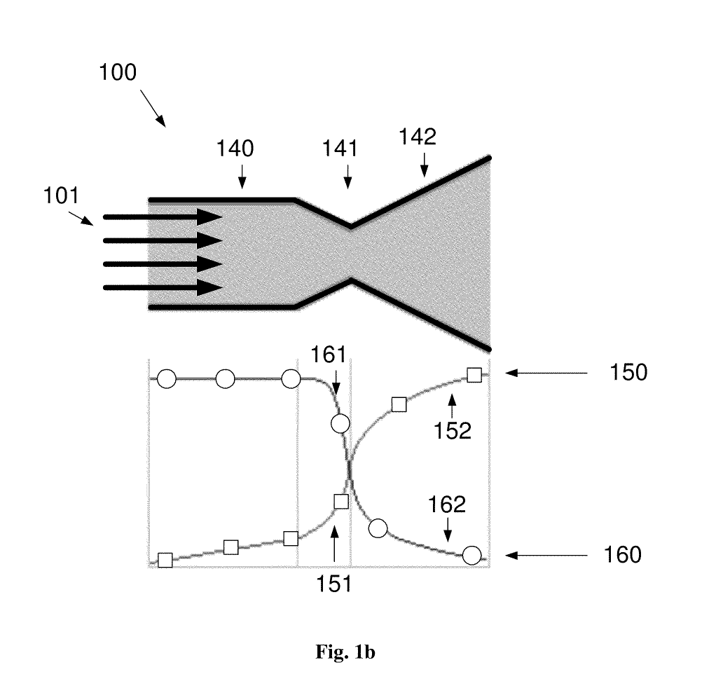

FIG. 2 is a prior art table-chart, showing weather conditions and how much water vapor is in air;

FIG. 2a is a prior art schematic representation of a breeze flux crossing through a cube of space;

FIG. 3 is an exemplary prior art schematic illustration of a phenomenon of atmospheric tornados arising.

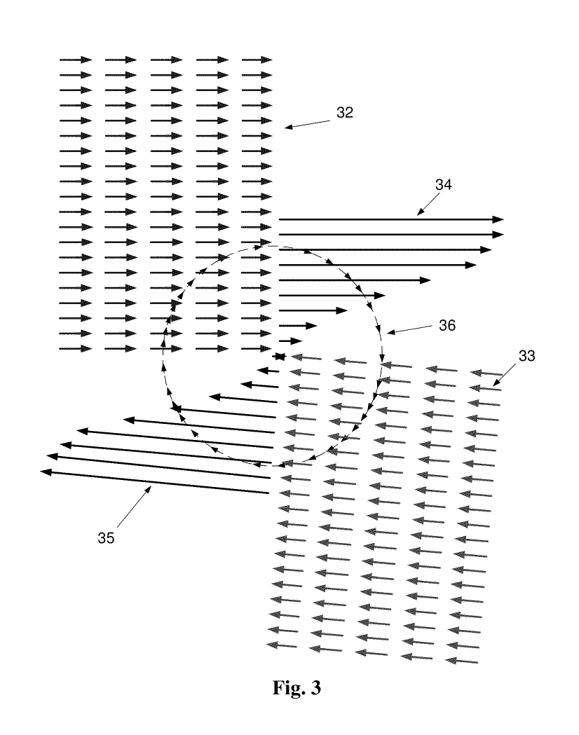

FIG. 4 is a schematic representation of a trivial passive catcher of water aerosols;

FIG. 5 is a schematic representation of a passive water aerosols catcher, which is built-in within a plant growing incubator, constructed according to an exemplary embodiment of the present invention;

FIG. 6 is a schematic representation of an ecologically clean passive catcher of water aerosols, constructed according to an exemplary embodiment of the present invention;

FIG. 7a is a schematic representation of an ecologically clean water condensation engine, having set of wing-like components, constructed according to an exemplary embodiment of the present invention;

FIG. 7b is a schematic representation of an ecologically clean water condensation engine, having set of wedge-like components, constructed according to an exemplary embodiment of the present invention;

FIG. 7c is a schematic representation of an ecologically clean water condensation engine, having set of wing-like components, constructed according to an exemplary embodiment of the present invention;

FIG. 8 is a schematic representation of a trivial profiled horn-tube [converging nozzle] and a water condensation engine, constructed according to an exemplary embodiment of the present invention;

FIG. 8a is a schematic representation of a modified profiled horn-tube, supplied by a redirecting duct, constructed according to an exemplary embodiment of the present invention;

FIG. 8b is a schematic representation of a modified profiled horn-tube, supplied by a cover, redirecting outer wind, according to an exemplary embodiment of the present invention;

FIG. 8c is a schematic representation of a modified profiled horn-tube, revolving and converging wind, according to an exemplary embodiment of the present invention;

FIG. 8d is a schematic representation of a modified profiled horn-tube revolving portions of wind flowing outside and converging portions of wind flowing within the horn-tube, constructed according to an exemplary embodiment of the present invention;

FIG. 8e is a schematic representation of a modified profiled horn-tube, having profiled contour comprising scaly fragments with wing-like details, constructed according to an exemplary embodiment of the present invention;

FIG. 8f is a schematic drawing showing a horn-like tapering tube, construed from coiled-up wings, according to an exemplary embodiment of the present invention;

FIG. 8g is a schematic drawing, showing a cascade of sequentially arranged truncated cones, constructed according to an exemplary embodiment of the present invention;

FIG. 9 is a schematic representation of a construction comprising cascaded horn-tubes as a water condensation engine, constructed according to an exemplary embodiment of the present invention;

FIG. 9a is a schematic drawing of a cascade of scaly horn-tubes, according to an exemplary embodiment of the present invention;

FIG. 9b is a schematic drawing of a cascade of wing-like details, converging wide front of oncoming wind, according to an exemplary embodiment of the present invention;

FIG. 9c is a schematic representation of a construction comprising cascaded horn-tubes and a water condensation engine, constructed according to an exemplary embodiment of the present invention;

FIG. 9d is a schematic top-view of a water condensation engine comprising in-line cascaded converging bells, narrow throat, supplied by two cylindrical chambers, and a diverging bell, constructed according to an exemplary embodiment of the present invention;

FIG. 10 is a schematic illustration of abundantly condensed water-aerosols and sublimated micro-flakes-of-snow behind wings of flying high-speed aircraft, ejecting a water adsorbing dust, according to an exemplary embodiment of the present invention.

FIG. 11 is a schematic illustration of rain creation by an aggregation of an airplane and attached sequence of horn-tubes and water condensation engine, constructed according to an exemplary embodiment of the present invention.

FIG. 12 is a schematic illustration of a top-view of a constructive solution for redirecting oncoming wind to power by the wind a water condensation engine oriented perpendicularly to the origin wind direction, constructed according to an exemplary embodiment of the present invention.

FIG. 13 shows schematically an exemplary system of solar thermal energy collection, where focusing plates are supplied with a cleaning construction, constructed according to an exemplary embodiment of the present invention.

### DETAILED DESCRIPTION OF PREFERRED EMBODIMENTS

The principles and operation of a method and an apparatus according to the present invention may be better understood with reference to the drawings and the accompanying description, it being understood that these drawings are given for illustrative purposes only and are not meant to be limiting.

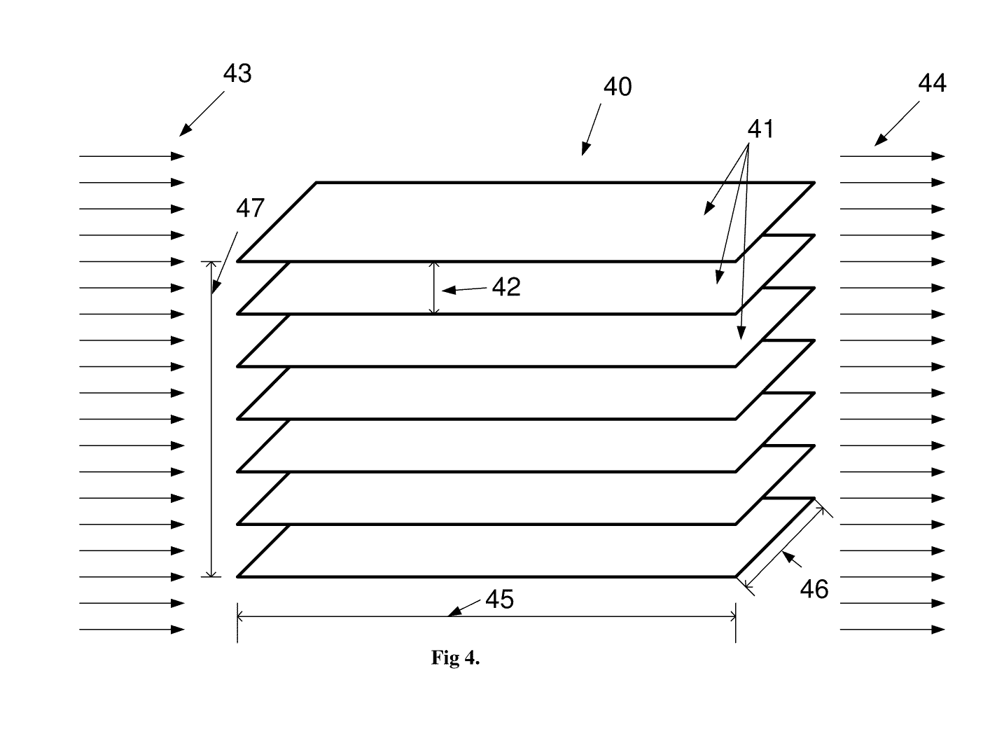

FIG. 4 is a schematic representation of a trivial passive catcher 40 of water aerosols. Catcher 40 has plates 41 for accumulation of naturally condensed dew. The plates 41 have length L 45, width w 46 and are distanced at intervals 42. The total height of passive catcher 40 is h 47. When catcher 40 is placed in an open space, humid windy air 43 crosses though the free space intervals 42 between plates 41. If weather conditions are such that humid windy air 43 comprises water aerosols, drops of dew arise on the surfaces of plates 41. The condition occurs when the air temperature falls below the “dew-point” temperature.

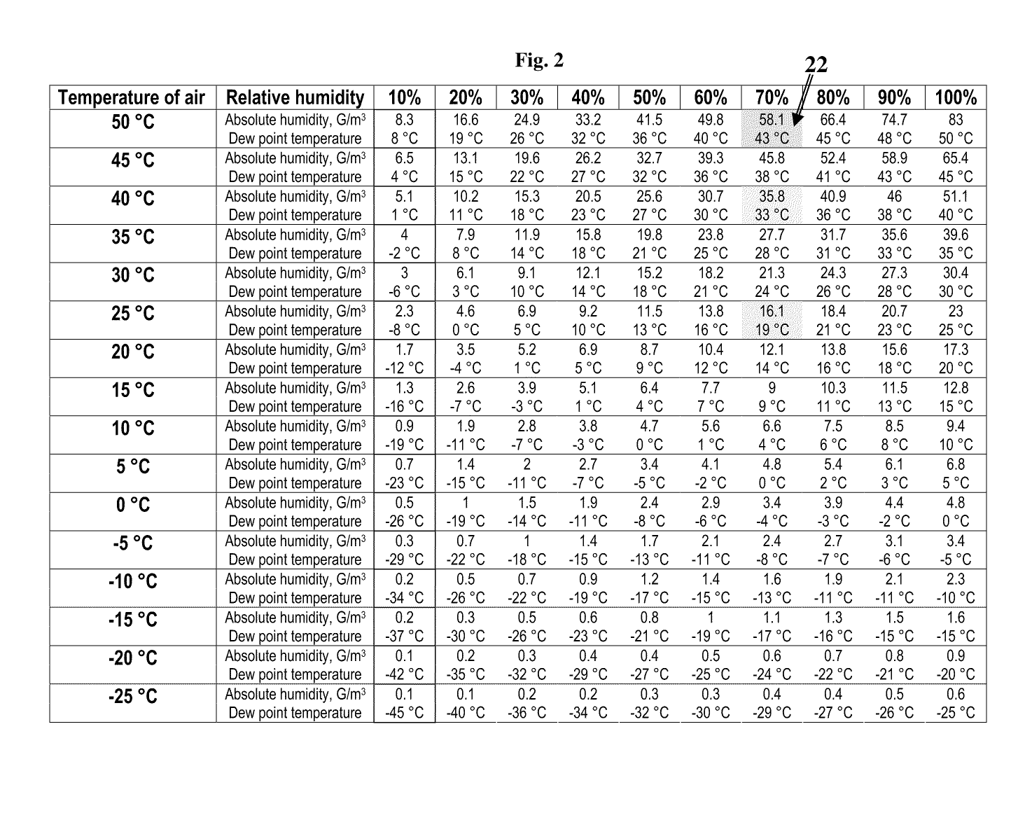

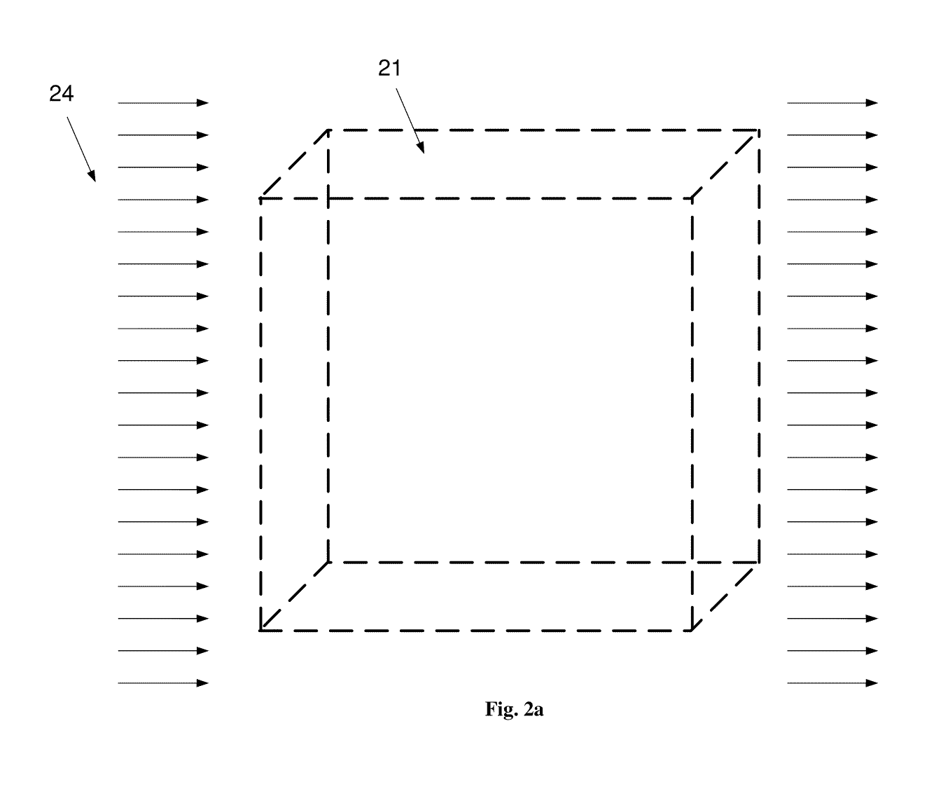

For example, referring back to prior art FIG. 2, considering normal summer conditions when the air temperature of an open space bathed in sun-rays is t₁=40° C. and the relative humidity is 70%, one finds the absolute humidity is equal to H₁=35.1 g/m³ and the dew-point temperature is 33° C. Considering a normal summer evening humidity of 70% and natural cooling of air below t₂=30° C., which corresponds to the absolute humidity of H₂=21.3 g/m³, one can expect the desired natural process of water condensing into water aerosols. Consider, in addition, that there is an evening breeze, for example, from the sea. Consider also a normal weather sea breeze of velocity ν=5 m/sec, which brings fresh portions of the humid air, and given exemplary dimensions of catcher 40: L=1 m, w=1 m, and h=1 m, an estimated flux of water aerosols, crossing the considered passive catcher space, is

$$( {H}_{1} - {H}_{2} ) Lwh \frac{v}{L} = ( 35.8 - 21.3 ) \times 5 = 72.5 g \text{/} sec$$

Taking into the consideration that normally the summer evening breeze continues for 3 hours, the estimated daily potential of water produced is 72.5×3×3600=783,000 g=783 kg. Catcher 40, however, is not constructed to provide sufficiently effective trapping of condensed water-aerosols. The partially dried air flux 44, leaving catcher 40, takes away water aerosols, which are not caught, and water vapors, which remain in a gaseous state.

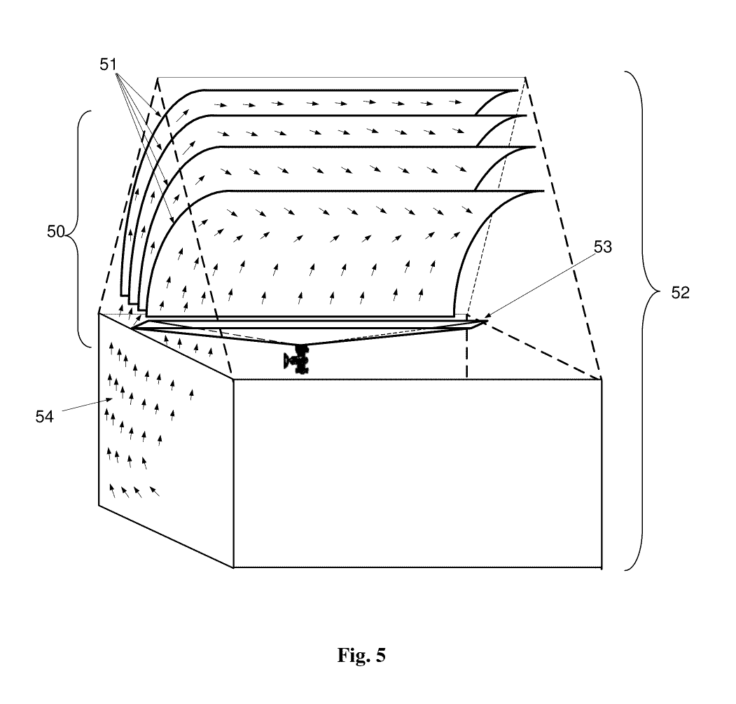

FIG. 5 is a schematic representation of a plant-growing incubator 52, having a built-in modified passive water aerosols catcher 50, comprising profiled plates 51, constructed according to an exemplary embodiment of the present invention. Normally, a plant-growing incubator is a closed conservatory, where air warming and ground watering are supported permanently. Sometimes it results in unwanted saturation of the air by water vapors. A portion of air, which is warmed and saturated by vapors, rises naturally. The rising air has two causes. First, according to the aforementioned Klapeiron-Mendeleev law, the warmer gaseous air is predisposed to expansion, thereby decreasing its own partial density and thereby becoming lighter and so rising.

The second cause results from the fact that air saturated by vapors has more water molecules, which are lighter than average molecules of dry air, so the vapors rise. Thus, the air warmed and saturated by water naturally is up-directed, where it is cooled by profiled plates 51, which have a lower temperature. The cooled air loses vapors, which are transformed into water aerosols, and drops of dew arise on the surfaces of profiled plates 51. The drops of dew trickle down to water collector 53. Cooled and dried air descends. The air circulation is shown schematically by the short arrows 54.

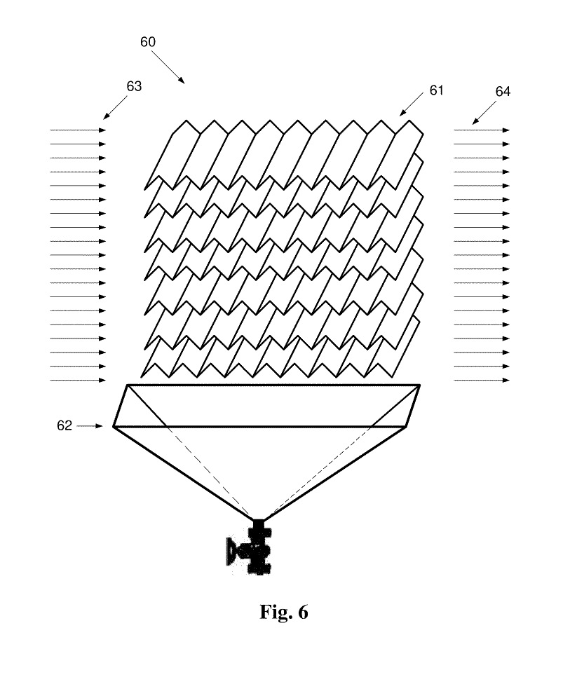

FIG. 6 is a schematic representation of an ecologically clean passive catcher 60 of naturally condensed aerosols, constructed according to an exemplary embodiment of the present invention. Ecologically clean passive catcher 60 is exposed to an oncoming humid wind 63, bringing the water aerosols. Ecologically clean passive catcher 60 has profiled plates 61. The oncoming humid wind 63 runs along profiled plates 61, losing water condensate, which turns into drops of dew trickling into water collector 62. The partially dried air flux 64 leaves ecologically clean passive catcher 60 and takes away water vapor, which remains in the gaseous state.

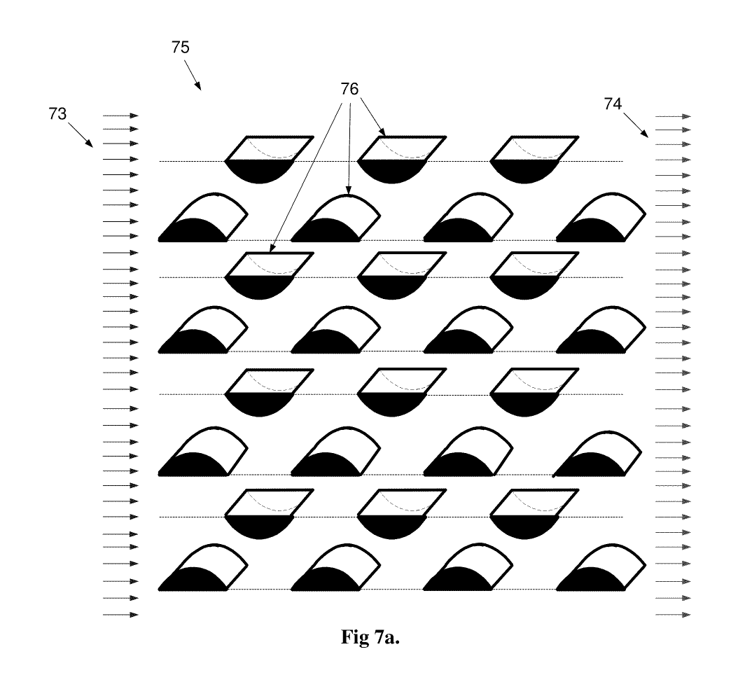

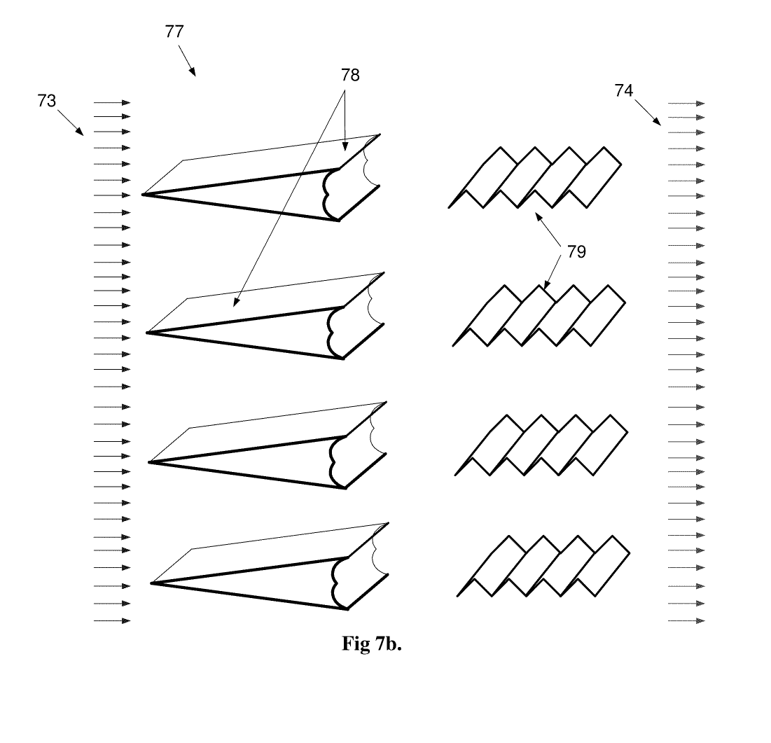

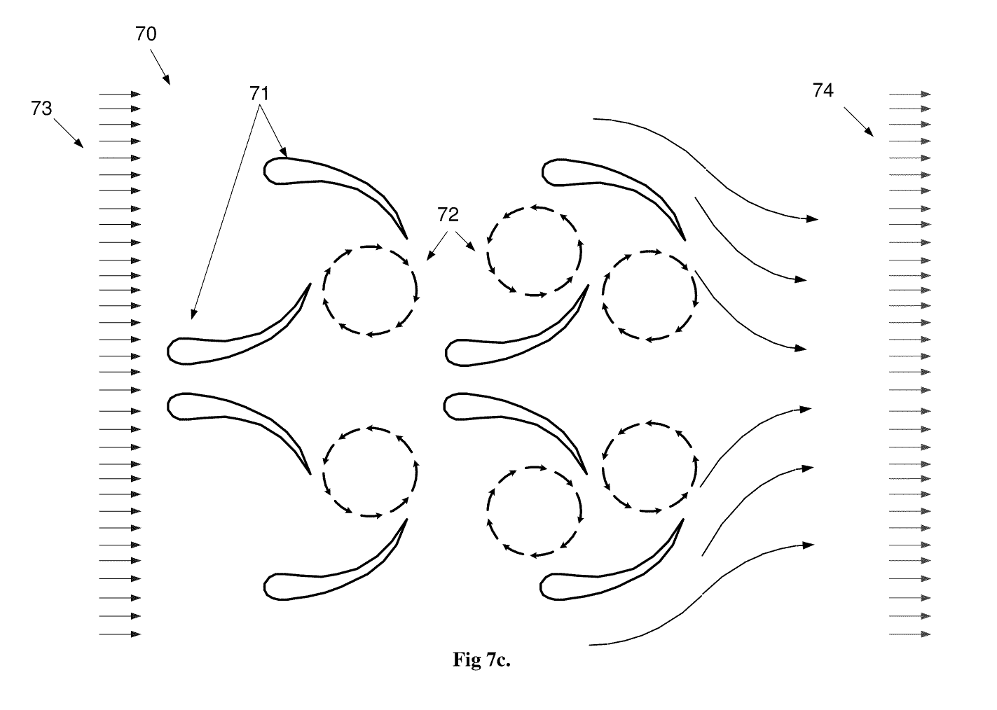

FIG. 7a is a schematic representation of a water condensation engine 75, having profiled wing-like details 76, constructed according to an exemplary embodiment of the present invention. The oncoming humid wind 73 runs along the profiled wing-like details 76. Profiled wing-like details 76 result in wing-like effects for acceleration of air portions and for making eddies and vortices that provoke the desired condensation of water vapor into aerosols. The aerosols are collected on the surfaces of profiled wing-like details 76, thereby forming drops of dew. Partially dried air flux 74 leaves the water condensation engine 75.

It follows, from the above description of water condensation triggering, that the arrangement, shapes and orientations of profiled wing-like details 76 may be optimized for higher efficiency of water condensation and collection. The described condensation triggering is relatively weak, because the natural breeze velocity is relatively slow.

FIG. 7b is a schematic representation of a water condensation engine 77, having profiled wedge-like details 78, constructed according to an exemplary embodiment of the present invention. The oncoming humid wind 73 runs along profiled wedge-like details 78. Profiled wedge-like details 78 result in effects for acceleration of air portions and for making eddies and vortices near the wider part of the wedge-like details. The vortices and eddies adsorb vapors from the air into water-aerosols. The aerosols are collected on the surfaces of a set of profiled corrugated details 79, thereby forming drops of dew. The described creation of eddies and vortexes by natural breeze results in relatively weak water-condensation triggering, so the slightly dried leaving air flux 74 remains substantially humid.

FIG. 7c is a top view schematic drawing of a water condensation engine 70 exposed to oncoming humid wind 73, constructed according to an exemplary embodiment of the present invention. Water condensation engine 70 comprises profiled curved wing-like details 71, which act on the oncoming air stream, resulting in eddying and the creation of high spin vortices 72. In addition, fresh portions of humid wind 73 make new portions of the circulating vortex in the same space. Assuming that input humid wind 73 is laminar, such a positive feedback loop re-enforces eddies resulting in said creation of high spin vortices 72. Vortices 72 have inherent pressure distribution, wherein inner pressure is lower and outer pressure is higher. An air portion, which is entrapped by one of high spin vortices 72, is accelerated and decompressed by the vortex. Adiabatically reduced pressure of the air portion is accompanied by decreased air portion temperature according to gas laws. The air cooling stimulates the desired condensation of the water vapors into aerosols.

There is an additional trigger for water condensation. Quickly revolving air is inherently accompanied by friction between the moving air molecules, causes ionization of the moist air molecules. The ionized molecules become the centers for condensation of water polar molecules into aerosols. The aerosols are collected on the surfaces of curved profiled wing-like details 71, thereby forming drops of dew. The drops of dew trickle into a water collector, which is similar to reference block 62 of FIG. 6, but not shown here. Also vortices 72 lose air portions. The advancing air portions constitute the dried air flux 74 leaving water condensation engine 70. Thus, in contrast to passive catcher 40 of FIG. 4 having naturally condensed dew, the details of water condensation engine 70 trigger the water condensation. The work for the triggering is performed at the expense of the oncoming wind's power. An arrangement and shapes of curved profiled wing-like details 71 may be optimized for more efficient water condensation.

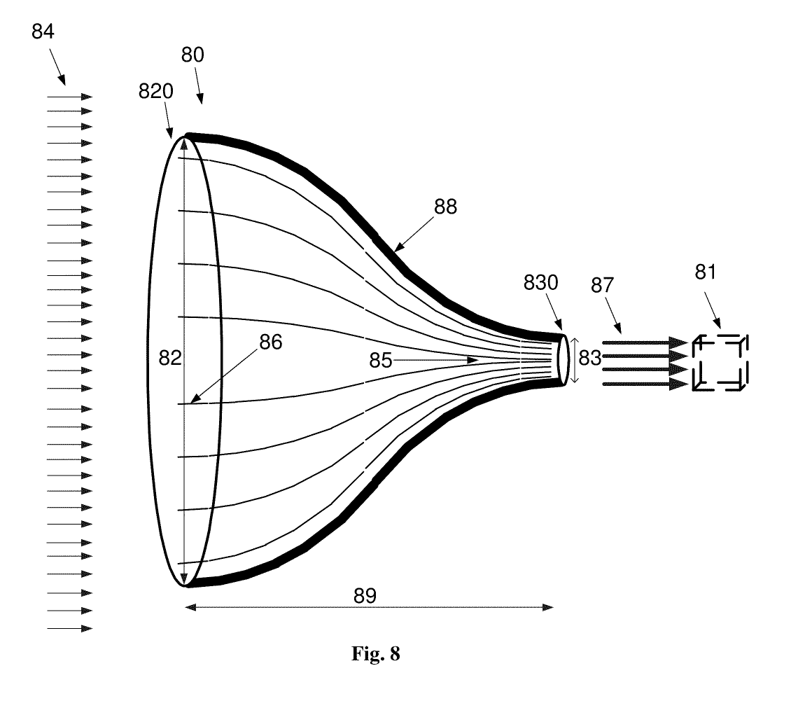

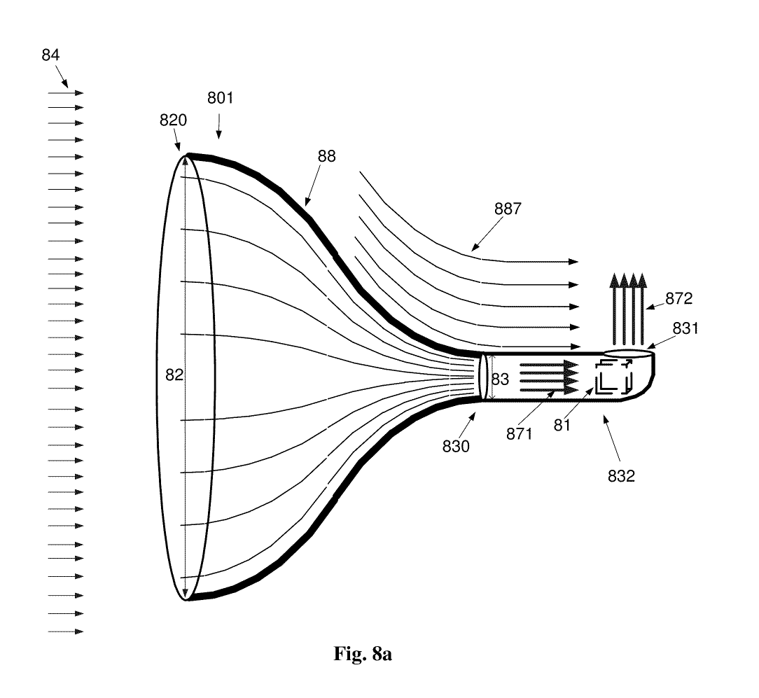

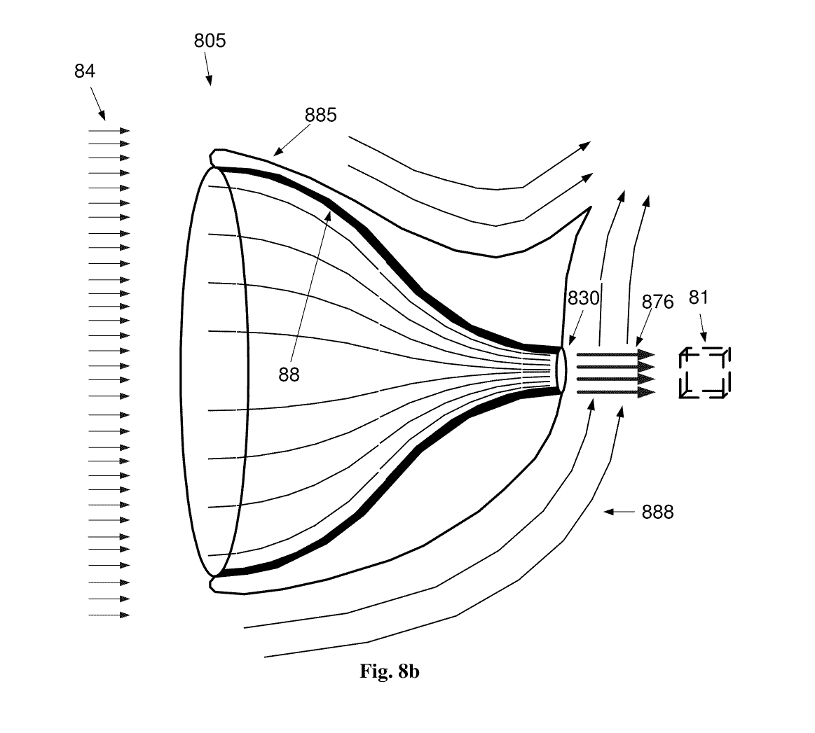

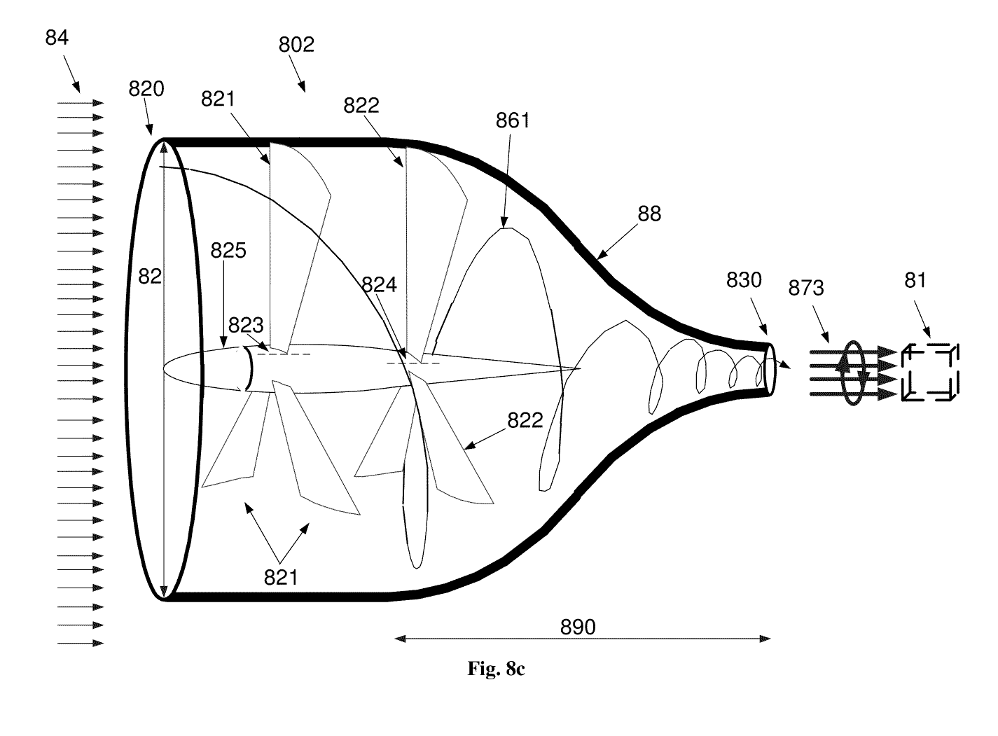

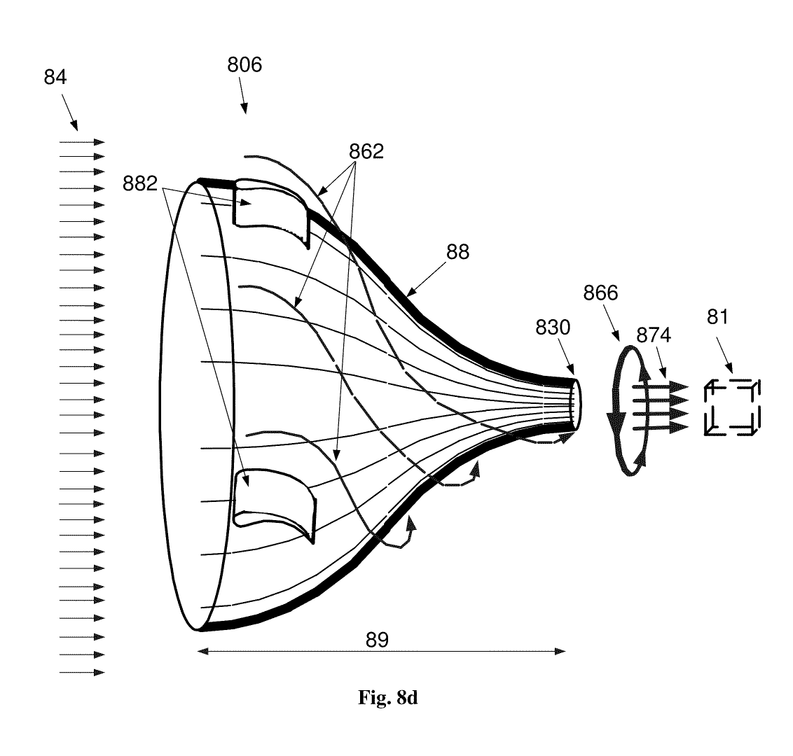

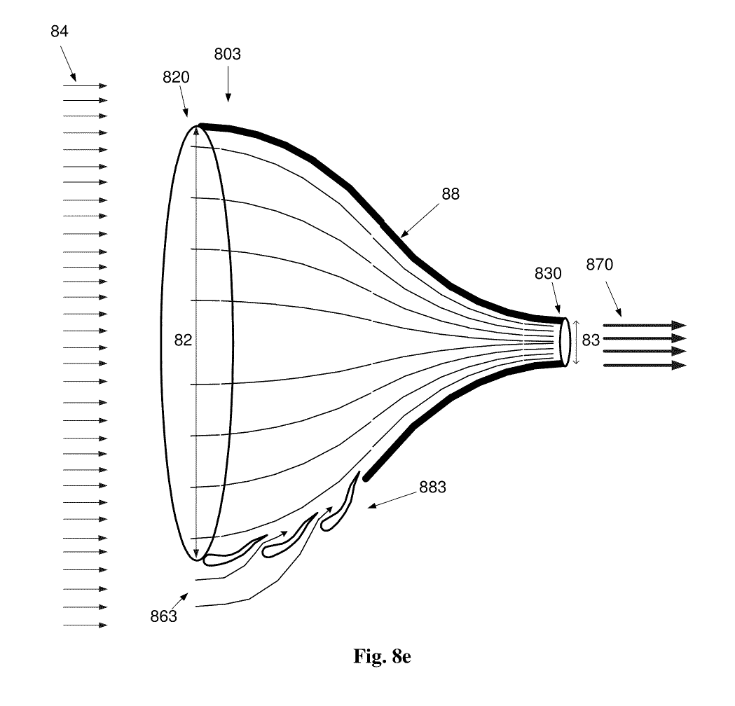

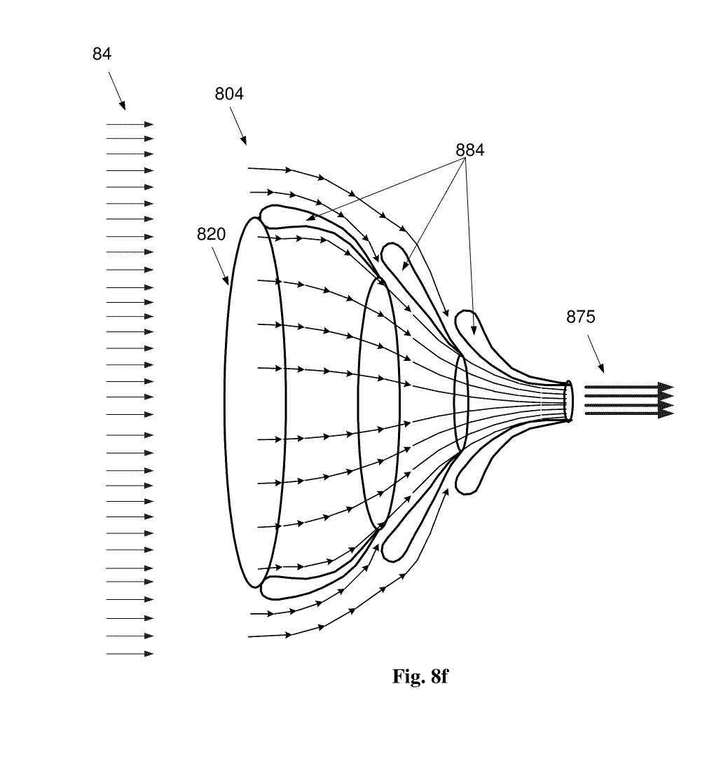

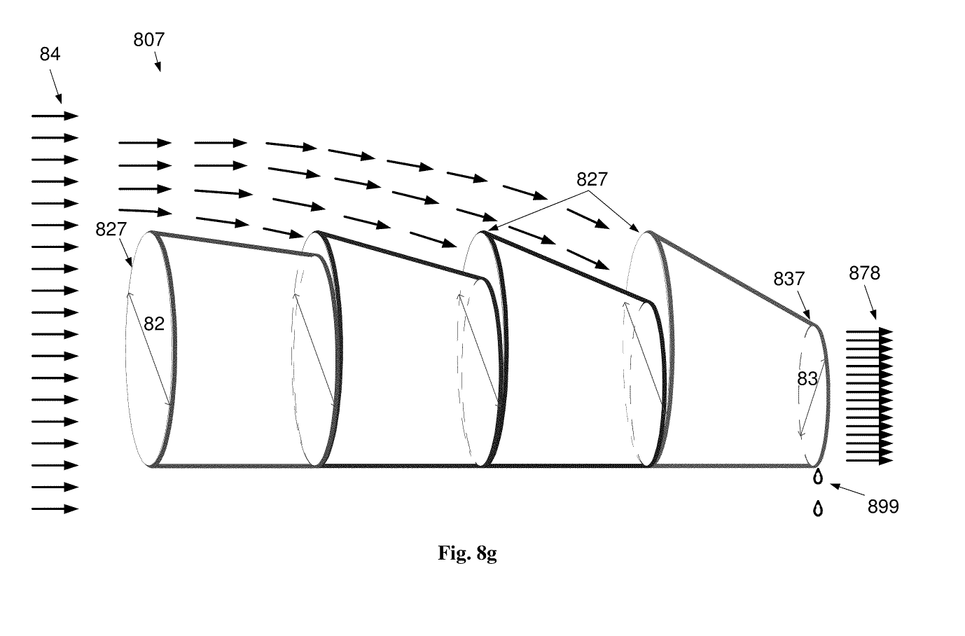

FIG. 8 is a schematic illustration of a trivial profiled horn-tube converging nozzle 80, which is positioned along the oncoming wind on its way to a water condensation engine 81, constructed according to an exemplary embodiment of the present invention. Water condensation engine 81 is not detailed here. In particular, it may be similar to either water condensation engine 75 of FIG. 7a or water condensation engine 77 of FIG. 7b or water condensation engine 70 of FIG. 7c described above.

Profiled horn-tube 80 preferably has a profile contour 88 similar to a cosine-function curve and substantially different diameters 82 and 83 of open butt-ends: inlet 820 and outlet 830. A flux of humid wind 84 enters profiled horn-tube nozzle 80 at inlet 820 having bigger diameter 82 and comes out through narrow throat outlet 830 having a smaller diameter 83. Cosine-like contour 88 and sufficient length 89 between but-ends 820 and 830 provide the conditions for laminar flow of the flux.

Smaller diameter 83 is large enough to justify neglecting any air viscosity phenomenon, while considering Bernoulli's principle. According to the continuity equation, the point 85 of the flux crossing throat outlet 830 of smaller diameter 83 experiences higher velocity than the velocity at the flux point 86 near inlet 820 having bigger diameter 82. Thus, assuming incompressible gas, the flux velocity is inversely-proportional to the cross-sectional area. For example, if inlet 820 diameter 82 throat outlet 830 is 3 times bigger than throat outlet 830 diameter 83, the velocity of output flux at point 85 is 3²=9 times higher than the velocity of the oncoming air flux at the point 86. Thus, trivial profiled horn-tube nozzle 80 provides the high speed output air stream 87 desired for input into water condensation engine 81.

Horn-tube nozzle 80 itself may play the role of a water condenser. According to Bernoulli's principle, static pressure P of a convectively accelerated portion of air is reduced. According to the Klapeiron-Mendeleev law concerning a hypothetical ideal gas state, and particularly for the case of slow-flowing wind approximated as an incompressible gas, i.e. for an isochoric process, according to Gay-Lussac's law,

$$\frac{P}{T} = Const ,$$

where P is the static pressure and T is the absolute temperature of the gas portion. This means that in an approximation of ideal gas laws, reduced static pressure P is accompanied by a proportional decrease of the associated air portion's absolute temperature T. The decreased temperature T may trigger the desired water condensation. However, it is not always practical to apply horn-tube nozzle 80, having a large area inlet 820, for oncoming wind convective acceleration. It is neither easy nor economical to build a wide horn-tube nozzle 80, for example, having inlet 820 diameter 82 of 30 m and throat outlet 830 diameter 83 of 1 m, that would be sufficiently durable for the case of a strong gust of wind.

FIG. 8a is a schematic drawing, showing a modified profiled horn-tube 801, similar to the mentioned converging nozzle 80, described referring to FIG. 8, constructed according to an exemplary embodiment of the present invention. Modified profiled horn-tube 801 is now supplied by a duct 832, which redirects the inner air stream 871 following through narrow throat 830 to an outlet 831 having a diameter equal to diameter 83 of narrow throat 830, and oriented perpendicular to the outer wind stream 887 direction. Thus, convectively accelerated air stream 871 is redirected to a perpendicular direction and exits as the air stream 872 crossing outer wind stream 887. Outer wind stream 887 sucks exiting air stream 872 according to the Coanda-effect, and this serves to further increase the speed of air stream 871 inside the horn-tube 801. Thereby the redirected out-coming air stream 872 is faster than the output air stream 87, described referring to FIG. 8.

FIG. 8b is a schematic illustration of another modified horn-tube 805, constructed according to an exemplary embodiment of the present invention. Modified horn-tube 805 is similar to converging nozzle 80, again having the inner walls cosine-like shape 88, described referring to FIG. 8, but now supplied by an outer non-symmetrical wing-like cover 885, redirecting the outer air stream 888 flowing around wing-like cover 885 past narrow throat outlet 830. Redirected outer air stream 888 sucks the exiting air stream 876 according to the Coanda-effect. Thus, air stream 876 is accelerated by the two mechanisms: convectively by inner walls converging cosine-like shape 88; and by Coanda-effect sucking, so that exiting air stream 876 is faster than exiting air stream at poin 87, described above with reference to FIG. 8.

FIG. 8c is a schematic representation of a yet further modified profiled horn-tube 802, causing a converging as well as revolving wind, according to another exemplary embodiment of the present invention. In contrast to converging nozzle 80, described above with reference to FIG. 8, yet further modified profiled horn-tube 802 is provided with stationary blades 821 fixed on a streamlined blade-grip 825, such that stationary blades 821 decline the inner wind stream on an angle 823 from the original direction of oncoming wind 84. The declined wind stream is imparted with a rotational moment by the coiled walls of horn-tube 802, and so propagates helically. The helical motion is shown schematically by a helical curve 861.

This revolving technique may be cascaded by stationary blades 822, following after stationary blades 821, and having a declining angle 824 bigger than preceding angle 823. Thus, by cascading such stationary blades, it becomes possible to create an air stream having a spiral motion of relatively short steps between the trajectory coils. The spiral trajectory, which accomplishes laminar spiral convectively flowing motion of air portions, allows for a reduced length 890 of converging segment 88 of modified profiled horn-tube 802 compared to length 89 described above with reference to FIG. 8. Again, inlet 820 has diameter 82.

If converging segment 88 of modified profiled horn-tube 802 is the same as converging nozzle 80 described above with reference to FIG. 8, then, assuming an incompressible gas, the spiral motion of air in the converging segment of modified profiled horn-tube 802 has the same velocity of forward air movement as the velocity of air flowing forward through the converging nozzle 80 described above with reference to FIG. 8, according to the continuity equation.

The added spin motion provides for two accelerations: a centripetal acceleration for changing the velocity direction and a convective acceleration for increasing an absolute value of the velocity with maintaining the same convective forward motion. The resulting air stream 873, exiting from modified profiled horn-tube 802 throat 830 into water condensation engine 81, has both components of convectively accelerated motion: forward and spinning. This combined convective acceleration is at the expense of potential energy of the convectively moving air portion, and so it is accompanied by air portion static pressure reduction, according to Bernoulli's principle and decreasing temperature according to Gay-Lussac's law. Moreover, the spinning motion is accompanied inherently by adiabatic radial redistribution of static pressure, wherein local static pressure near the rotation axis is lower. Thus, air portions which are near the rotation axis are also cooled adiabatically. The decreased temperature triggers water condensation.

In view of the description referring to FIG. 8c, it will be evident to a person skilled in the art, that many kinds of constructive solutions might be applied alternatively to guide blades 821 and 822 and streamlined blade-grip 825 to achieve the desired spinning feature.

FIG. 8d is a schematic representation of a modified profiled horn-tube 806, having revolving portions of wind flowing outside and converging portions of wind flowing within, according to an exemplary embodiment of the present invention. In contrast to the trivial profiled horn-tube converging nozzle 80 described above with reference to FIG. 8, modified profiled horn-tube 806 is provided with wing-like blades 882, which are arranged externally. Wing-like blades 882 redirect the outer portions of wind, whose forward motion is converged in alignment with cosine-like profile contour 88. Again, horn-tube 806 has length 89.

The resulting trajectories of the wind portions emanating from oncoming wind 84, and flowing outside horn-tube 806, are helical curves 862, having forward, revolving and converging components of motion. The revolving component of the outer wind portions behind throat outlet 830 is shown schematically by the circulating arrows 866. Revolving air 866 has lower static pressure in the center of the rotation. This reduced static pressure behind throat outlet 830 sucks-out convectively accelerated inner portions of air, thereby accelerating the exiting stream 874 into water condensation engine 81. As a result, exiting stream 874 is faster than exiting stream 87, which is described above with reference to FIG. 8.

FIG. 8e is a schematic illustration of a newly modified profiled horn-tube 803, according to an exemplary embodiment of the present invention. Newly modified profiled horn-tube 803 does not have a completely solid cosine-like contour 88, but instead incorporates scaly fragments comprising wing-like details 883, which provide for additional portions 863 of flowing air to enter between wing-like details 883 into the inner space of newly modified horn-tube 803.

The phenomenon can be considered to effectively provide a squaring increase of oncoming flux front 84, such that the effective square of oncoming flux front 84, being subject to convective acceleration, is wider than the square of the cross-section enclosed by wide inlet 820 having bigger diameter 82. The portion of oncoming flux 84, increased by additional portion 863, being under inner convective acceleration, further increases the speed of the output air stream 870, past diameter 83 of narrow throat 830, according to the continuity equation. Thus, output air stream 870 is faster than output air stream 87, described above with reference to FIG. 8.

FIG. 8f is a schematic illustration of a cascade 804 of coiled-up wings 884, according to an exemplary embodiment of the present invention. Such construction results in a rapidly exiting narrow air stream 875, by converging a wide front of oncoming wind 84, wherein the effective area of the oncoming front is wider than the area of the circular cross-section, which is enclosed by wide inlet 820 of cascade 804 of coiled-up wings 884.

FIG. 8g is a schematic illustration of a cascade of sequentially arranged truncated cones 807 operating as a water condensation engine, constructed according to an exemplary embodiment of the present invention. All of sequentially arranged truncated cones 807 have inlets 827 having cross-sections of equal diameters 82, and each succeeding truncated cone 807 has an outlet cross-section narrower than the outlet cross-section of previous truncated cone 807, such that the last truncated cone's outlet 837 is of the smallest diameter 83. Such construction results in a rapidly exiting narrow air stream 878 by converging a wide front of oncoming wind 84, wherein an effective area of the oncoming front is wider than the area of the cross-section enclosed by the first of inlets 827 of sequentially cascaded truncated cones 807. Convectively accelerated and thereby cooled outgoing air stream 878 emits droplets of condensed water 899.

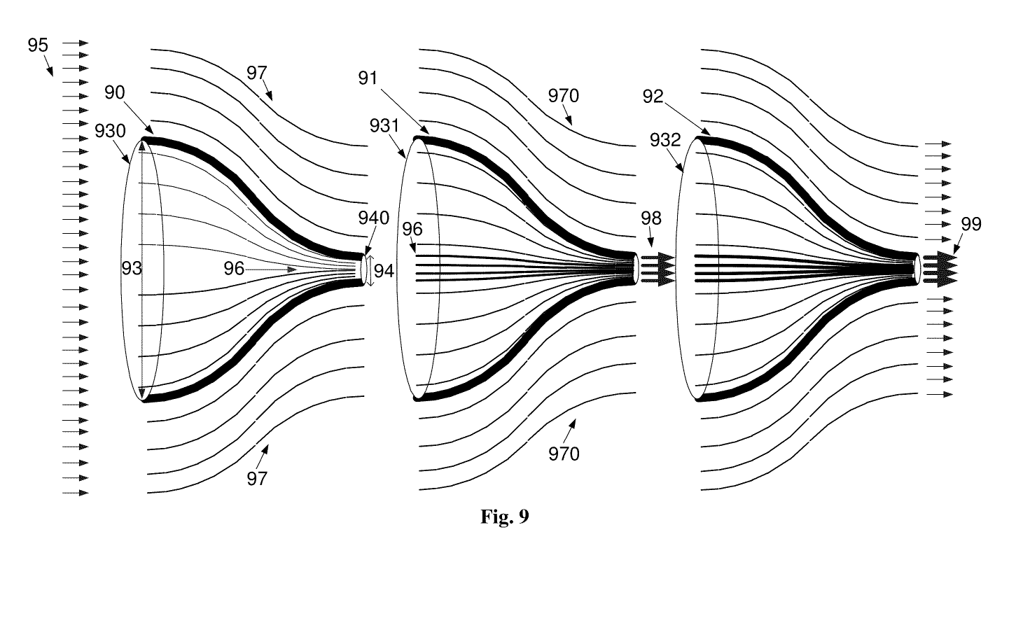

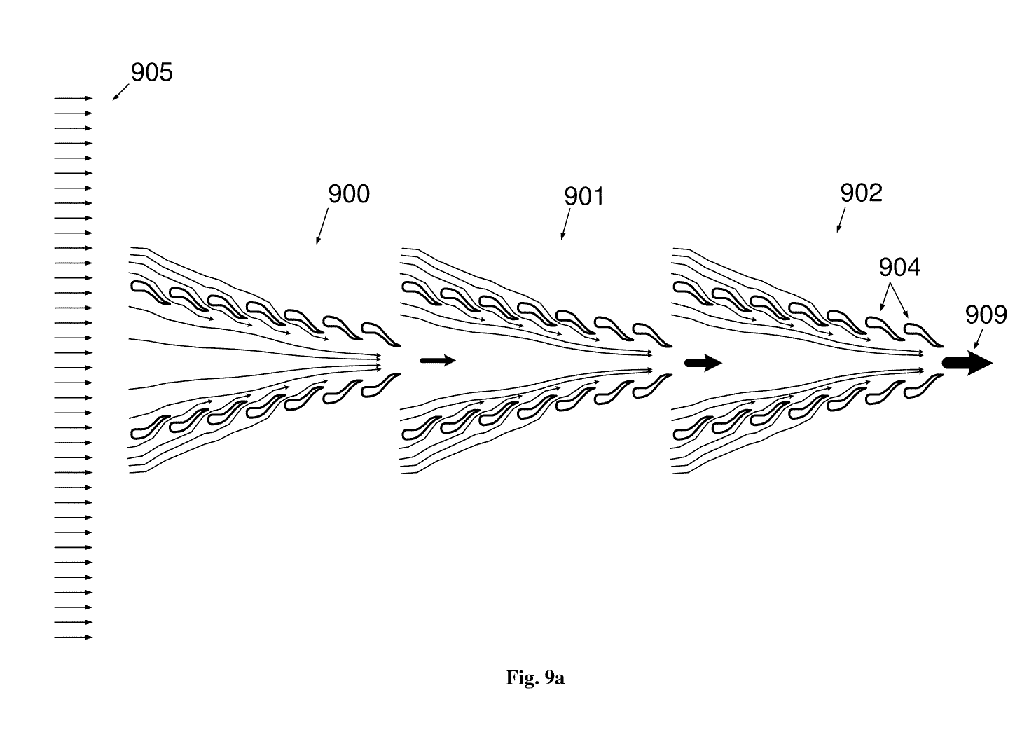

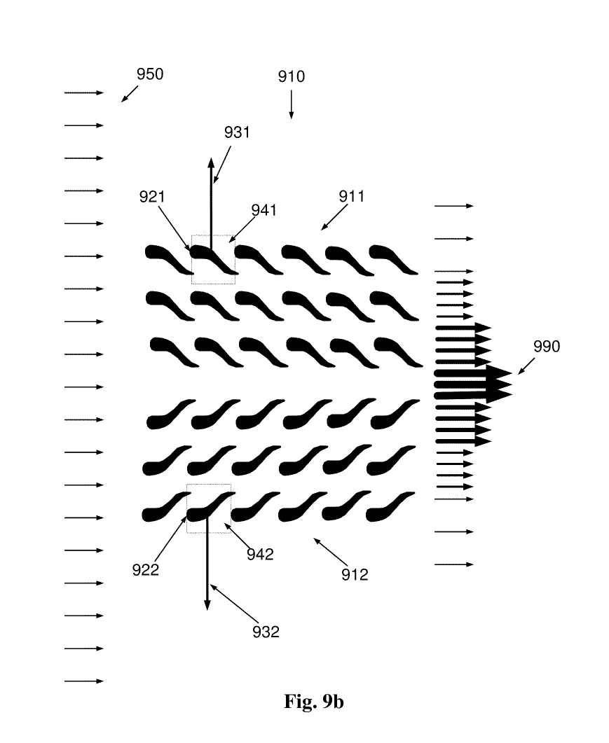

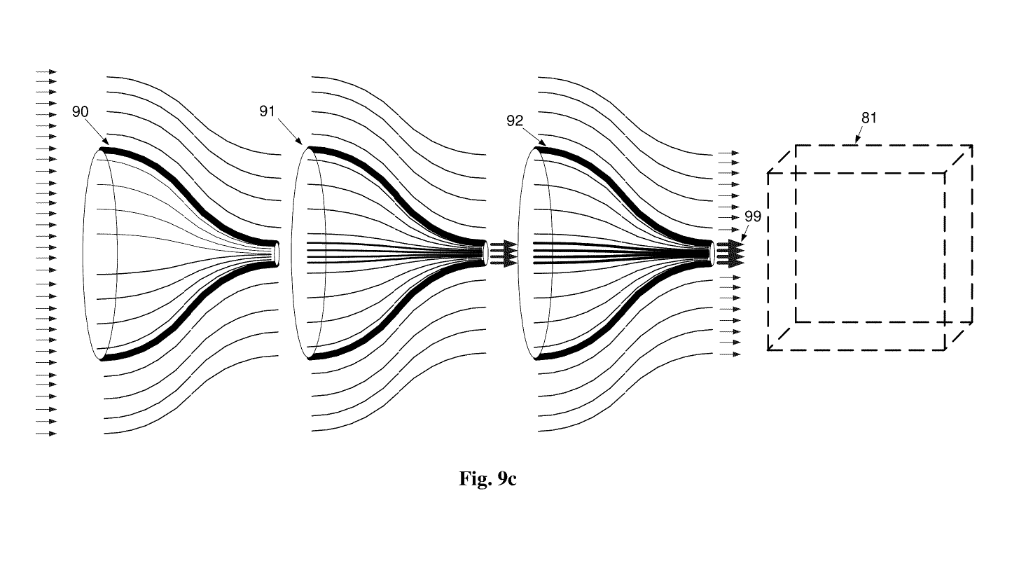

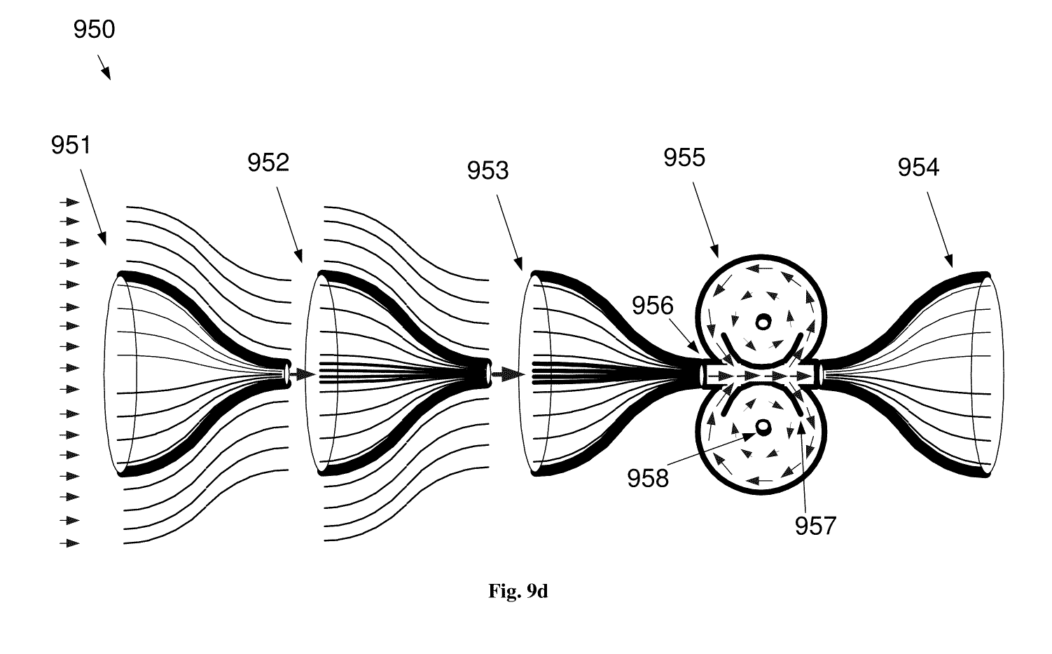

FIG. 9 is a schematic illustration of cascaded profiled horn-tubes 90 having the inlet 930, 91 having the inlet 931 and 92 having the inlet 932, that operate as a water condensation engine, according to an exemplary embodiment of the present invention. The profiled horn-tube 90 has substantially different diameters 93 and 94 of open butt-ends at inlet 930 and throat outlet 940, respectively. A flux of humid wind 95 enters profiled horn-tube 90 from inlet 930, having bigger diameter 93, and comes out through throat outlet 940, having smaller diameter 94.

For example, if narrow throat outlet 940 diameter 94 is smaller than the inlet 930 diameter 93 by 3 times, then according to the continuity equation, the output flux 96 velocity near throat outlet 940 is 3²=9 times higher than the velocity of air flux 95 near inlet 930. Moreover, part of humid wind flux 95 flows around profiled horn-tube 90 forming outer flowing stream 97.

Furthermore, both fluxes, inner flux 96, exiting from narrow throat outlet 940, and outer flux 97, entering cascaded profiled horn-tube 91. Profiled horn-tube 91 transforms both inner flux 96 and outer flux 97 into the resulting flux 98, exiting the narrow throat outlet of profiled horn-tube 91. The velocity of resulting flux 98 is almost double the velocity of flux 96. Next cascaded profiled horn-tube 92 provides yet added fresh outside portions 970 of wind 95 to the resulting re-enforced flux 99, having a cross-sectional area equal to the area of the narrow throat outlet of profiled horn-tube 92, and having a velocity that is almost triple that of the velocity of flux 96.

Thus, cascading many profiled horn-tubes, it is possible to concentrate a huge front of humid wind into the narrow resulting flux of extra-high velocity. If the extra-high velocity air stream thereby created reaches the speed of sound, a shock wave is launched. The shock wave launching is at the expense of the internal energy of the air, resulting in “shock” decrease of the air temperature, thereby triggering the process of abundant vapor condensation into water-aerosols.

In view of the foregoing description referring to FIG. 9, it will be evident to a person skilled in the art that various modifications of horn-tubes may be cascaded. For example, a cascade of modified horn-tubes 806 (FIG. 8d) constitutes an aggregated converging system (not shown here) improved by revolving both inner and outer air streams.

FIG. 9a is a schematic illustration of a cascade of scaly horn-tubes 900, 901, and 902, constructed according to an exemplary embodiment of the present invention. In contrast to aforementioned in FIG. 9 profiled horn-tubes 90, 91, and 92 having solid contours, horn-tubes 900, 901, and 902 have scaly contours, comprising cascaded wing-like details 904. Such a construction provides a wide converging front of oncoming wind 905 into a narrow fast outgoing stream 909.

FIG. 9b is a schematic illustration of an arrangement 910 of cascaded wing-like details 911 and cascaded mirror-reversed wing-like details 912, constructed according to an exemplary embodiment of the present invention. In particular, an individual wing-like detail 921 is a constituent of cascaded wing-like details 911 and an individual mirror-reversed wing-like detail 922 is a constituent of cascaded mirror-reversed wing-like details 912. So-called lifting forces, shown here as the vectors 931 and 932, act from the flowing portions 941 and 942 of the oncoming wind 950 on streamlined opposite wing-like details 921 and 922 correspondingly. According to the Third Law of Newton, the opposite wing-like details 921 and 922 act to corresponding portions 941 and 942 of the flowing wind in opposite directions.

Thus, the opposite exemplary wing-like details 921 and 922, and, in general, 911 and 912, act on oncoming wind 950 converging air stream front into a narrow and fast outgoing air stream 990. Such an aggregation of opposite wing-like details 911 and 912 operates as a water condensation engine by accelerating humid air streams, according to an exemplary embodiment of the present invention. It is evident to a person skilled in the art, that opposite wing-like details 911 and 912 may be implemented by the coiling-up of wings.

FIG. 9c is a schematic illustration of the aforementioned water condensation engine 81, arranged behind cascaded profiled horn-tubes 90, 91 and 92, described hereinbefore, referring to FIG. 9, according to an exemplary embodiment of the present invention. In this case the high-speed air flux 99 provides a highly efficiency water condensation engine 81. It is important that the size of each cascaded profiled-tube may be commensurate with the size of water condensation engine 81 in order for the construction to remain reasonably feasible.

In view of the foregoing description referring to FIG. 9c, it will be evident to a person skilled in the art that various modifications of engines, operating on natural wind power and destined for various purposes, may be applied instead of water condensation engine 81. For example, a so-called wind turbine destined for electricity generation may be arranged behind the cascaded horn-tubes, according to an exemplary embodiment of the present invention.

FIG. 9d is a schematic top-view of a water condensation engine 950, comprising in-line, cascaded, converging bells 951, 952, and 953, a narrow throat 956 supplied by two closed cylindrical chambers 955, and a diverging bell 954. The in-line cascaded converging bells 951, 952, and 953 concentrate and accelerate the oncoming wind, reaching the narrow throat 956. The fast air stream flows around rounded blades 957 sucking air from and blowing air portions into chambers 955 in a positive feedback loop, that results in fast rotating and permanently refreshing vortices, shown schematically by short arrows within chambers 955. The vortices created have inherent pressure distribution, wherein inner pressure is lower and outer pressure is higher. Adiabatically reduced pressure of the air portion is accompanied by decreasing temperature. Air cooling near the centers of vortices stimulates the desired condensation of water vapors into aerosols. There are water catchers 958 at the centers of the vortices rotation. Also, dew arises on the surfaces of blades 957.

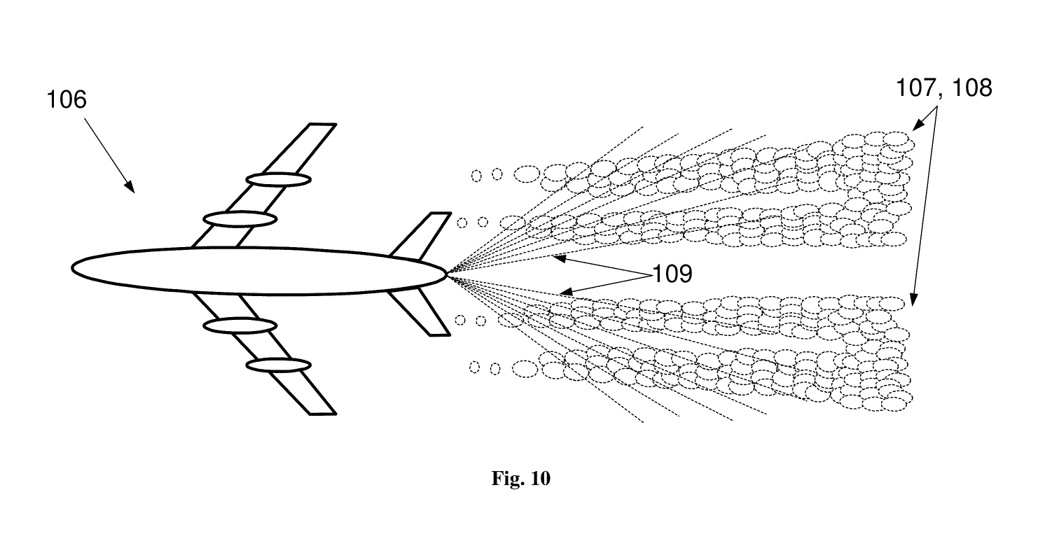

FIG. 10 is a schematic illustration of highly condensed water-aerosols 107 and sublimated micro-flakes-of-snow 108, which are observed behind the wings of high-speed aircraft 106. Aircraft 106 ejects a water adsorbing dust 109. Water adsorbing dust 109 causes water-aerosols 107 and sublimated micro-flakes-of-snow 108 to aggregate in rain-drops and/or bigger flakes of snow, which fall down. This exemplary extravagant technique for harvesting water from air may become useful for extinguishing a forest fire.

In contrast to the aforementioned method to supply much water using a very heavy airplane, relatively light high-speed aircraft 106 needs substantially less fuel, because work performed by aircraft 106 is mainly for eddying air and producing vortices, but not for lifting heavy water reservoirs. Moreover, in this case high-speed aircraft 106 is designed for fast operation, which may be of the highest priority for the exemplary case.

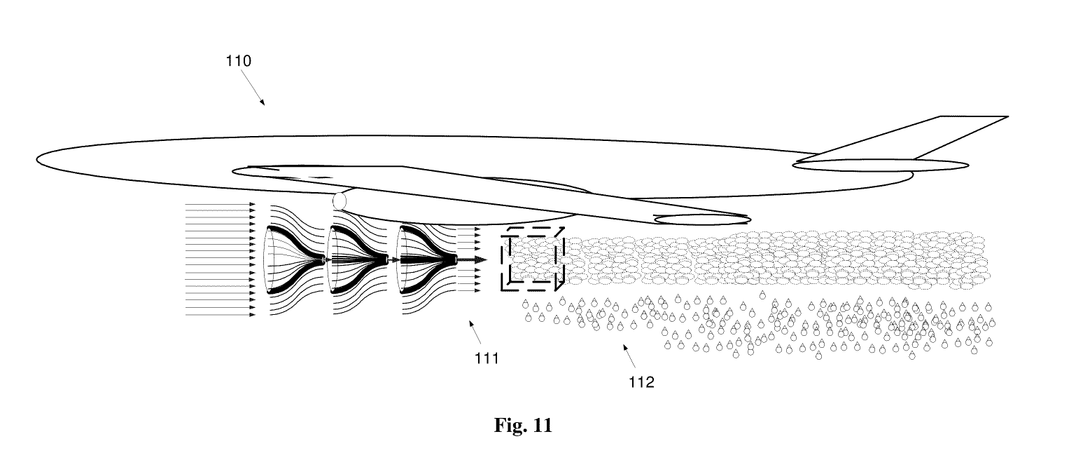

In contrast to the use of high-speed aircraft 106, FIG. 11 is a schematic illustration of a slower airplane 110, having an attached construction 111, which is similar to the apparatus described with reference to FIG. 9c, and constructed according to an exemplary embodiment of the present invention. Such an aggregation may be applied for effectively extracting rain 112 from air in order to extinguish forest fires.

Referring again to FIG. 9c, at times topology may restrict the preferable orientation of a long in-line cascade of as many as 200 horn-tubes. For example, if only the sea shoreline is free for the in-line cascading of the horn-tubes and the direction of the sea-wind is substantially perpendicular to the shoreline, the construction shown in FIG. 9c, being exposed to the oncoming wind perpendicularly, will not operate efficiently.

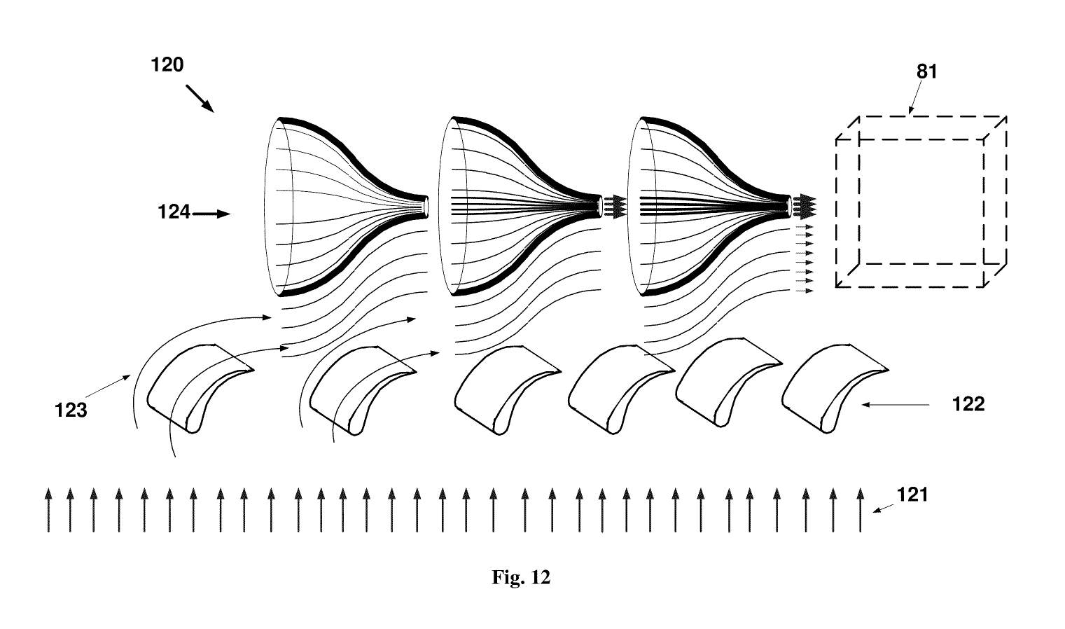

FIG. 12 is a schematic top-view of a constructive solution 120 for the in-line cascaded profiled horn-tubes 124 and water condensation engine 81, which are similar to the construction described above with reference to FIG. 9c, but in FIG. 12 the orientation is perpendicular to the direction of side-wind 121, according to an exemplary embodiment of the present invention. The profiled wing-like blades 122 are added to redirect side-wind 121 according to the Coanda-effect. The air flux 123 is redirected to substantially coincide with the direction of in-line cascaded horn-tubes 124. Constructive solution 120 operates efficiently for wind directions either along or perpendicular to in-line cascaded profiled horn-tubes 124.

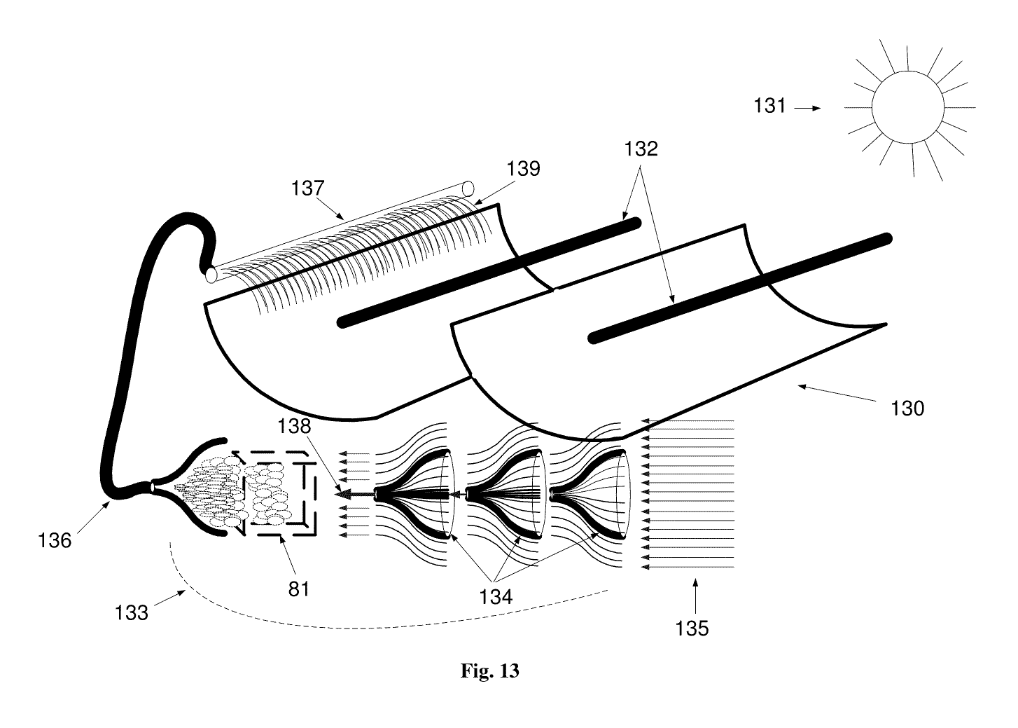

FIG. 13 is a schematic illustration of an exemplary system for solar thermal energy collection, where focusing plates 130 are supplied with a cleaning sub-system 133, constructed according to an exemplary embodiment of the present invention. Focusing plates 130 are constructed as long parabolic mirrors, which are exposed to the sun 131. The sunlight is reflected by the focusing plates 130 and concentrated on Dewar tubes 132, arranged along the focal axes of the parabolic mirrors comprising focusing plates 130. A heat transfer fluid, preferably oil, runs through Dewar tubes 132 to absorb the concentrated sunlight. Normally, focusing plates 130 occupy a very large area.

Cleaning sub-system 133, in principle, is similar to the construction described with reference to FIG. 9c. Cleaning sub-system 133 comprises a very long cascade of horn-tubes 134. For example, there may be 200 horn-tubes 134 (here only 3 horn-tubes 134 are shown), arranged near focusing plates 130. A very long cascade of horn-tubes 134 sucks a wide front of oncoming wind 135 as described above with reference to FIGS. 9 and 9c.

Cleaning sub-system 133 comprises a water condensation engine 81, which is now supplied with a hose 136 having a douche 137 on the output butt-end. A very long cascade of horn-tubes 134 results in a converged narrow flux 138 of air at extra-high velocity, providing that water condensation engine 81 operates efficiently. The distilled water, condensed from the air, is transmitted to the focusing plates 130 through hose 136 due to the air flux, which emanates from water condensation engine 81. The running distilled water 139 cleans the surfaces of focusing plates 130 from natural dust.

I claim:

1. An ecologically clean passive catcher of water aerosols, comprising profiled plates exposed to a humid wind, wherein said humid wind brings fresh portions of water-aerosols, and wherein said profiled plates are arranged at free intervals and are oriented in accordance with the direction of said humid wind, such that said humid wind enters into said passive catcher and flows around said profiled plates, and such that said water-aerosols naturally gather into drops of dew and are collected on the surfaces of said profiled plates.

2. An ecologically clean water condensation engine, comprising a set of profiled details exposed to humid wind bringing water vapors, wherein said details act on said humid wind, thereby providing convective acceleration of arriving air portions, accompanied by a decrease in static pressure, according to Bernoulli's principle and causing eddying and vortices in said arriving air portions and a decrease in the inherent inner gas static pressure, wherein said decrease in static pressure is accompanied by a temperature decrease according to gas state laws,
such that said temperature decrease triggers condensation of said water vapors into water aerosols and drops of dew, and said drops of dew collect upon surfaces of said profiled details.

3. The ecologically clean water condensation engine of 2, wherein said profiled details have one of wing-like and wedge-like profiles.

4. An ecologically clean water condensation engine exposed to humid wind bringing water-vapors, said water condensation engine comprising:
a profiled horn-tube; and
a set of profiled details,
wherein said profiled horn-tube further comprises two open butt-ends, differing by at least doubly in cross-sectional area, and wherein said profiled horn-tube is oriented such that said humid wind enters the bigger butt-end of said profiled horn-tube and proceeds to the smaller butt-end, and wherein the narrowing cross-section of said profiled horn-tube forces said humid wind to be reduced in cross-sectional area and to increase in velocity, said reduction being inversely proportional to said reduced cross-sectional area, according to the continuity equation, and according to Bernoulli's principle there occurs a reduction in gas static pressure of the accelerated humid wind and an accelerated out-flow, and wherein the reduced gas static pressure is accompanied by a decrease in temperature according to the gas state laws, and wherein; said out-flow represents a fast flux arriving at said set of profiled details, and wherein said fast flux runs along said profiled details, which act on said fast flux, thereby providing convective acceleration of air portions accompanied by a reduction in static pressure according to Bernoulli's principle and causing eddying and vortices within said air portions, and wherein said reduction in static pressure is accompanied by a temperature reduction according to the gas state laws, such that said temperature reduction triggers off condensation of said water-vapors into water-aerosols and drops of dew and said drops of dew collect upon surfaces of said profiled details.

5. The ecologically clean water condensation engine of claim 4, wherein said profiled details have one of wing-like and wedge-like profiles.

6. The ecologically clean water condensation engine of claim 4, wherein said profiled horn-tube further comprises at least one scaly fragment comprising wing-like scale-details, said wing-like scale-details provide that additional portions of said humid wind enter between adjacent elements of said wing-like scale-details into the inner space of said horn-tube.

7. An ecologically clean wind concentration engine exposed to humid wind bringing water-vapors, said wind concentration engine comprising a cascade of at least two sequential profiled horn-tubes, wherein each of said profiled horn-tubes further comprises two open butt-ends differing in cross-sectional area, wherein each of said at least two sequential profiled horn-tubes is from bigger cross-section to smaller cross-section substantially in the same direction of said humid wind, and wherein said humid wind flows around said cascade of at least two sequential following profiled horn-tubes and is transformed into an air flux out-flow, and wherein said humid wind comprises the first air stream flowing around the first of said at least two profiled horn-tubes, wherein each previous said profiled horn-tube transforms the previous oncoming air stream into the next said oncoming air stream wind flowing around the next of said at least two sequential profiled horn-tubes, and wherein an inner portion is defined for each said profiled horn-tube as a portion of said oncoming air stream and said inner portion enters into said bigger cross-sectional area butt-end of said associated profiled horn-tube and an outer portion is defined for each said profiled horn-tube as a portion of said oncoming air stream and said outer portion flows around the outer side of said associated profiled horn-tube, and wherein said inner portion proceeds to said smaller cross-section butt-end within said profiled horn-tube, such that the narrowing cross-section of said profiled horn-tube forces said inner portion to reduce said stream cross-sectional area and, according to the continuity equation, to increase the velocity of said stream, said increase being inversely proportional to said reduced cross-sectional area of said stream cross-section, thereby forming an inner faster out-flowing stream, and wherein said outer portion proceeds to said smaller cross-section butt-end of said profiled horn-tube in alignment with the outside profile of said profiled horn-tube, and thereby forming an outer out-flowing portion of said humid wind-out stream, and according to the Coanda suction effect drawing forward fresh outer-adjacent air portions of said humid wind, thereby forming an additional fresh out-flowing stream, such that the three streams: said inner fast out-flow stream; said outer out-flow stream; and said fresh out-flow stream together form the next said oncoming air stream, and wherein two of said streams: said inner fast out-flow and said outer out-flow form the next inner portion of said next oncoming air stream, and wherein said next inner portion is effectively faster than the previous said inner portion, and said fresh out-flow forms the next said outer portion of said next oncoming air stream, and wherein the last said oncoming air stream flowing-out from the last of said at least two sequential profiled horn-tubes, comprises a fast out-flow air flux,
such that said first oncoming air stream of said humid wind is transformed into said fast out-flow air flux according to the continuity equation, wherein static pressure of said fast out-flow air flux is reduced relative to the static pressure of said first oncoming air stream according to Bernoulli's principle and the temperature of said fast out-flow air flux is decreased relative to the temperature of said first oncoming air stream according to gas state laws,
and such that the decreased temperature of said fast out-flow air flux triggers condensation of said water-vapors into water-aerosols and drops of dew, wherein said drops of dew collect on the inner surfaces of said wind concentration engine.

8. The ecologically clean wind concentration engine exposed to humid wind of claim 7, wherein at least one of said profiled horn-tubes has at least one scaly fragment comprising wing-like scale-details, which provide that additional portions of flowing said humid wind enter between said wing-like scale-details into the inner space of said at least one of said profiled horn-tubes.

9. The ecologically clean water condensation engine of claim 7 further comprising a set of profiled details, wherein said humid wind comprises an oncoming air stream flowing around said wind concentration engine, and wherein said oncoming air stream comprises a cross-sectional area substantially bigger than the cross-sectional area of said wind concentration engine, and wherein said substantially bigger cross-section is at least doubly bigger than said cross-sectional area of said wind concentration engine, and wherein said wind concentration engine sucks said oncoming air stream according to the Coanda-effect, thereby forming a fast out-flowing air flux according to the continuity equation, wherein static pressure of said fast out-flowing air flux is reduced relative to the static pressure of said oncoming air stream according to Bernoulli's principle and the temperature of said fast out-flowing air flux is decreased relative to the temperature of said oncoming air stream according to the gas state laws, and wherein said temperature decrease triggers condensation of said water-vapors into water-aerosols, and wherein said cooled fast out-flowing air flux reaches said set of profiled details, and wherein said set of profiled details acts on said fast out-flowing air flux, thereby providing acceleration of air portions and resulting in eddying and vortices with said air portions, and wherein the inherent inner pressure of said air portions is reduced, accompanied by a further temperature decrease, said temperature decrease triggering condensation of said water-vapors into water-aerosols and drops of dew,
such that said drops of dew collect upon surfaces of said profiled details.

10. The ecologically clean water condensation engine of claim 9, wherein said profiled details further comprise wing-like profiles.

11. The ecologically clean water condensation engine of claim 9, wherein said profiled details further comprise wedge-like profiles.

12. The ecologically clean water condensation engine of claim 9, wherein said profiled details further comprise round-like profiles creating air vortices.

13. An ecologically clean water condensation engine exposed to a humid wind bringing water-vapors, said water condensation engine comprising:
a cascade of at least two sequential profiled horn-tubes; and
a set of profiled details,
wherein each of said profiled horn-tubes further comprise two open butt-ends differing in cross-section area, and wherein each of said sequential profiled horn-tubes is oriented such that the direction from said bigger cross-section butt-end to said smaller cross-section butt-end is substantially the same as the direction of said humid wind, and wherein said humid wind flows around said cascade of at least two sequential profiled horn-tubes and is transformed into a out-flowing air flux reaching said set of profiled details, and wherein said humid wind further comprises a first oncoming air stream flowing around a first said profiled horn-tube, and wherein each previous said profiled horn-tube transforms said previous oncoming air stream into the next said oncoming air stream flowing around the next of said at least two sequential profiled horn-tubes, and wherein an inner portion is defined for each of said profiled horn-tube as a portion of said oncoming air stream entering said bigger cross-sectional butt-end of an associated profiled horn-tube and an outer portion is defined for each said profiled horn-tube as a portion of said oncoming air stream flowing around the outer side of said associated profiled horn-tube, and wherein said inner portion proceeds to said smaller cross-sectional butt-end within said profiled horn-tube, and wherein the narrowing cross-section of said profiled horn-tube forces said inner portion to reduce said stream cross-sectional area, and wherein, according to the continuity equation, the stream velocity increases in inverse proportion to the square of said reduction in stream cross-sectional area, and wherein the static pressure of said fast out-flowing air flux is reduced according to Bernoulli's principle, and wherein the temperature of said fast out-flowing air flux is decreased according to the gas state laws, thereby forming a cooled inner fast out-flowing stream, and wherein said outer portion proceeds to said smaller cross-sectional butt-end of said profiled horn-tube in alignment with the outside profile of said profiled horn-tube forming an outer out-flowing stream, and wherein, according to the Coanda suction effect, said stream draws forward fresh outer-adjacent air portions of said humid wind, forming an additional fresh out-flow stream, such that the three streams: said cooled inner fast out-flowing stream; said outer out-flowing stream; and said fresh out-flowing stream together form the next said oncoming air stream, wherein the two streams: said cooled inner fast out-flowing stream and said outer out-flowing stream form the next inner portion of said next oncoming air stream, wherein said next inner portion is effectively faster and colder than the previous said inner portion, and said fresh out-flowing stream forms the next said outer portion of said next oncoming air stream,
and such that the last said oncoming air stream, out-flowing from the last of said at least two sequential profiled horn-tubes comprises a fast cold out-flowing air flux,
and such that the last said oncoming air stream, out-flowing from the last of said at least two sequential profiled horn-tubes comprises a fast cold out-flowing air flux reaching said set of profiled details,
and such that said set of profiled details acts on said fast cold out-flowing air flux provides acceleration of air portions and eddying and vortices among said air portions, and wherein inherent inner pressure of said air portions is reduced accompanied by a further temperature decrease, said temperature decrease triggering condensation of said water-vapors into water-aerosols and drops of dew.

14. The ecologically clean water condensation engine of claim 13, wherein said profiled details further comprising at least one of wing-like profiles and wedge-like profiles.

15. The ecologically clean water condensation engine of claim 13, wherein at least one of said profiled horn-tubes further comprises at least one scaly fragment comprising wing-like scale-details, such that said scale-details provide additional portions of said humid wind entering between said wing-like scale-details into the inner space of said at least one of said profiled horn-tubes.

16. A wind concentration engine exposed to humid wind, said wind concentration engine comprising at least two opposite wing-like details, said details defining a lifting force acting from flowing wind on said streamlined wing, wherein said at least two opposite wing-like details are arranged such that said wind acts with said lifting force on each of said at least two opposite wing-like details, and wherein said lifting forces are directed in opposite directions, thereby pushing away said at least two opposite wing-like details from each other.

17. A wind concentration engine exposed to oncoming humid wind comprising:
a streamlined wing defined as a spatial-configuration having a asymmetrical streamlined contour, wherein the upper side of said contour is longer than the lower side of said contour and a lifting force acting on said streamlined wing from said air stream, and said engine comprising at least one said coiled-up streamlined wing, wherein said coil has at least one turn around coil-axis directed along the direction of said oncoming humid wind, and said coiling-up is such that said lower side of said streamlined wing is turned into said coil-axis, and wherein said coiled-up streamlined wing converges oncoming humid wind into said coil-axis.

18. The wind concentration engine of claim 17, wherein said coil is one of a circle, an ellipse, helical line and a spiral of Archimedes.
